(19) United States
(12) Patent Application Publication
(10) Pub. No.: US 2005/0038673 A1
(43) Pub. Date: Feb. 17, 2005

(54) Method and system for automated pharmaceutical research and reporting

(75) Inventors: Tad B. Stookey, Austin, TX (US); Steven K. Bergeron, Cedar Park, TX (US)

Correspondence Address: Tad B. Stookey;Precerche Inc., 11044 Research Blvd., Bldg. B. Suite 420, Austin, TX, 78759, US

(73) Assignee: Precerche, Inc.

(21) Appl. No.: 10/779,020

(22) Filed: Feb. 13, 2004

Related U.S. Application Data
(60) Provisional application No. 60/447,433, filed on Feb. 14, 2003.

(51) Int. Cl. G06F 17/60

(52) U.S. Cl. 705/2

(57) ABSTRACT

A system for automated management of a clinical trial for pharmaceutical, biomedical, and medical device development that facilitates pharmaceutical research and reporting, including at least one site server 222, at least one computing device 218 configured to collect primary clinical trial data, and an authorized user accessible computing device 234. The central server 232 is configured to receive the primary clinical trial data from each site server 222, to store the primary clinical trial data, to create secondary clinical trial data based on the primary clinical trial data, and to transmit the primary and secondary clinical trial data to the authorized user accessible computing device 234. Also provided is a method for automatically managing a clinical trial for pharmaceutical, biomedical, and medical device development in order to facilitate pharmaceutical research and reporting, which further includes a computer readable signal containing a set of instructions to perform a corresponding method.

### CROSS-REFERENCE TO RELATED PATENT APPLICATIONS

This patent application claims the benefit of U.S. Provisional Patent Application No. 60/447,433, filed Feb. 14, 2003, entitled, “Method and System for Automated Pharmaceutical Research and Reporting.”

### FIELD OF THE INVENTION

This disclosure pertains to automated pharmaceutical research and reporting. More particularly, this disclosure relates to clinical trial management for drug development.

### BACKGROUND OF THE INVENTION

The present paper-based clinical trial process has fundamental problems. It appears that pressures related to cost and timing are significantly increasing within the field of drug development, taking into account numerous factors, including: cost containment pressures; attempts to overcome limitations on internal capacity; a desire to improve the timeline for evaluating and developing new drugs and/or devices; the desire to increase the percentage of development costs that are variable as compared to fixed costs; the need to perform research relating to new drugs or devices in multiple countries simultaneously; the response to increasingly stringent government regulations in various countries; and the desire to use all available expertise to supplement internal design and development capabilities.

According to the Tufts Center for the Study of Drug Development, the average cost to develop a new prescription drug is $802 million and it takes between 10 and 15 years to develop a new prescription drug and obtain approval to market it in the United States. As the investment required to develop new drugs continues to increase, an opportunity is created to help speed the drug development process or make this process more efficient.

The Tufts Center for the Study of Drug Development has also stated that total development time for biopharmaceuticals rose steadily between 1982 and 2001.

One response to these problems has been adoption of electronic data capture (EDC)/clinical trial management systems (CTMS). However, most available EDC/CTMS systems are hard-to-use, piecemeal, and disparate And do not address the processes of conducting a study.

The reality is that authorized users are under increasing pressure to complete clinical trials more quickly and cost effectively. Unfortunately, authorized users lack timely accessibility to study data & metrics, delaying critical management decisions. Inventory management is often highly ineffective, and timely patient recruitment is a constant challenge. Available technology products are expensive, piece-meal, partial solutions that are difficult to use.

What is needed is a clinical trial management solution having high usability that facilitates reduced costs and development times, while also facilitating improved access to and use of ongoing clinical trial information.

This disclosure teaches such a clinical trial management solution. These and other advantages of the invention, as well as additional inventive features, will be apparent from the description of the invention provided herein.

### BRIEF DESCRIPTION OF THE DRAWINGS

For a more complete understanding of the present invention, and the advantages thereof, reference is now made to the following brief descriptions taken in conjunction with the accompanying drawings, in which like reference numerals indicate like features.

FIG. 1 shows an overview of the database structure, according to an embodiment of the present invention.

FIG. 2 depicts the Basic Protocol Information (BPI) aspect, according to an embodiment of the present invention.

FIG. 3 depicts the Shipping aspect of the program, according to an embodiment of the present invention.

FIG. 4 describes the Patent Information portion of the present invention. Then the patient is scheduled within that time frame, according to an embodiment of the present invention.

FIG. 5 provides a block diagram illustrating Patient Scheduling, according to an embodiment of the present invention.

FIG. 6 shows the Updates aspect, according to an embodiment of the present invention.

FIG. 7 shows a reporting aspect which provides all the information from the study at the fingertips of the user, according to an embodiment of the present invention.

FIG. 8 shows a process flow diagram depicting a patent visit, according to an embodiment of the present invention.

The Authorized user Information Interface appears in FIG. 9, according to an embodiment of the present invention.

The Contact Information Interface appears in FIG. 10, according to an embodiment of the present invention.

The Protocol Information Interface appears in FIG. 11, according to an embodiment of the present invention.

The Structure Information Interface appears in FIG. 12, according to an embodiment of the present invention.

The Visit Information Interfaces appear in FIGS. 13 and 14, according to an embodiment of the present invention.

Select Sites and Contact Interfaces appear in FIGS. 15 and 16, according to an embodiment of the present invention.

The Patient Information Interface appears in FIG. 17, according to an embodiment of the present invention.

A Patient Barcode for use with the present invention appears in FIG. 18, according to an embodiment of the present invention.

The Screening Visit Interface appears in FIG. 19, according to an embodiment of the present invention.

The Protocol the patient is being tested for is selected through the interface of FIG. 20, according to an embodiment of the present invention.

The Screening Visit Assessments are shown on the screen appearing in FIG. 21, according to an embodiment of the present invention.

The program indicates on the interface of FIG. 22 all of the current answers to the user so the answers can be checked for errors, according to an embodiment of the present invention.

The Patient Visit Interface appears in FIG. 23, according to an embodiment of the present invention.

The Patient Scheduling Interface is shown in FIG. 24, according to an embodiment of the present invention.

Reports are printed, emailed, or looked at on screen by many users, such as appearing in FIG. 25, including Authorized users, Sites, Investigators, and Study Coordinators, according to an embodiment of the present invention.

Sample Study Metrics Reports appear in FIG. 26, according to an embodiment of the present invention.

The Authorized user and the Site check inventory interface of FIG. 27 is used in the Randomization process of the Patient Visit 01 and for Reporting, according to an embodiment of the present invention.

FIG. 28 depicts a network overview, according to an embodiment of the present invention.

FIG. 29 depicts information flowing from specification to study implementation, according to an embodiment of the present invention.

FIG. 30 shows an interface containing graphical representation available in performing quantitative and historical analysis, according to an embodiment of the present invention.

FIG. 31 illustrates a typical dynamic data control server configuration, according to an embodiment of the present invention.

FIG. 32 depicts a typical home/site configuration, according to an embodiment of the present invention.

FIG. 33 illustrates a typical infrastructure for networking across the Internet, according to an embodiment of the present invention.

FIG. 34 shows a process flow for defining a protocol using an XML-based representation, according to an embodiment of the present invention.

FIG. 35 illustrates a general purpose computing system that may be part of a network of such computing systems for employing an embodiment of the method and system for automated pharmaceutical research and reporting of the present invention.

### DETAILED DESCRIPTION OF THE INVENTION

The disclosure teaches a system for automated management of a clinical trial for pharmaceutical, biomedical, and medical device development that facilitates pharmaceutical research and reporting, including at least one site server each being associated with and communicably coupled to at least one computing device configured to collect primary clinical trial data using electronic data capture by providing interfaces through which users can enter data and a central server communicably coupled via a full-time, public network to each site server and communicably coupled via a full-time, public network to an authorized user accessible computing device. Each computing device configured to collect primary clinical trial data is adapted to validate data entered. Each site server is configured to transmit the primary clinical trial data to the central server. The central server is configured to receive the primary clinical trial data from each site server, to store the primary clinical trial data, to create secondary clinical trial data based on the primary clinical trial data. Thereafter the primary and secondary clinical trial data may be transmitted to the authorized user accessible computing device.

The disclosure also teaches a method for automatically managing a clinical trial for pharmaceutical, biomedical, and medical device development in order to facilitate pharmaceutical research and reporting. Electronic data is captured corresponding to primary clinical trial data by the use by a user of a computing device configured with interfaces adapted to collect primary clinical trial data. The electronic data is validated. The electronic data distributing across a full-time, public network after said data has been validated from the corresponding computing device to a central server. Secondary clinical trial data is created based on the primary clinical trial data. The primary and secondary clinical trial data is stored. The stored primary and secondary clinical trial data is made available by the central server to be accessed across the full-time, public network by an authorized user accessible computing device.

The disclosure also teaches a computer-readable signal capable of being propagated between computers and which contains a set of instructions for a general purpose computer having a user interface comprising a pointing device and a screen display. The set of instructions includes an input routine operatively associated with the user interface for permitting a user to select an icon displayed on the screen display with said mouse, the icon associated with an applications program accessible to the computer. Execution of the applications program performs a method for automatically managing a clinical trial for pharmaceutical, biomedical, and medical device development in order to facilitate pharmaceutical research and reporting. Electronic data is captured corresponding to primary clinical trial data by the use by a user of a computing device configured with interfaces adapted to collect primary clinical trial data. The electronic data is validated. The electronic data distributing across a full-time, public network after said data has been validated from the corresponding computing device to a central server. Secondary clinical trial data is created based on the primary clinical trial data. The primary and secondary clinical trial data is stored. The stored primary and secondary clinical trial data is made available by the central server to be accessed across the full-time, public network by an authorized user accessible computing device. A run routine for executing said applications program selected by the user with the mouse is also included, as is a display routine responsive to the run routine for displaying on the screen display text or images generated by the applications program.

Other aspects, objectives and advantages of the invention will become more apparent from the remainder of the detailed description when taken in conjunction with the accompanying drawings.

The present invention provides a method and system for automated pharmaceutical, biomedical, and medical device research and reporting, and more particularly a method and system that eliminates or substantially reduces error, reporting and analysis time, and costs in the obtaining and generating pharmaceutical field test results. Thus, the present invention helps to reduce the cost and duration of clinical trials.

To enable an understanding of the present invention, the following description first provides an organizational view of the databases employed for managing and automatically reporting pharmaceutical, biomedical, and medical device research results. Thereafter, the description explains, through a series of annotated user interface diagrams, the process of the present invention for managing the research data gathering and related functions.

Although this description provides exemplary embodiment aspects of the present invention, the present invention clearly contemplates additional alternative embodiments for use in not only the pharmaceutical industry, but in other industries with similar data gathering requirements.

Precerche is a trademark of Precerche, Inc. which identifies Precerche, Inc.'s method and system for automated pharmaceutical research and reporting, any given implementation of which may be covered by at least one of the appended claims. Protocol Prophet is a trademark of Precerche, Inc. which identifies Precerche, Inc.'s basic protocol information aspect, any given implementation of which may be covered by at least one of the appended claims. Report Genie is a trademark of Precerche, Inc. which identifies Precerche, Inc.'s reporting aspect, any given implementation of which may be covered by at least one of the appended claims. InterRx is a trademark of Precerche, Inc. which identifies Precerche, Inc.'s total solution system for integrating disparate aspects of clinical study management, any given implementation of which may be covered by at least one of the appended claims. Xprotocol is a trademark of Precerche, Inc. which identifies Precerche, Inc.'s XML-based protocol representation, any given implementation of which may be covered by at least one of the appended claims.

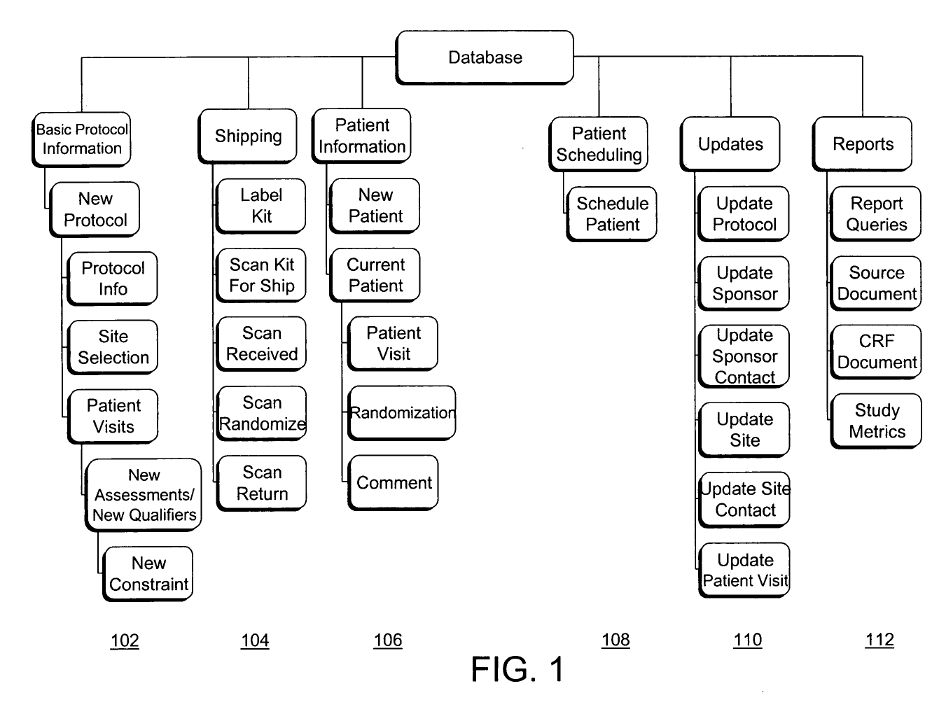

FIG. 1 shows an overview of the database structure of an embodiment of the invention. The overall database structure includes six components/aspects: basic protocol information (BPI) 102, shipping 104, patient information 106, patient scheduling 108, updates 110, and reports 112.

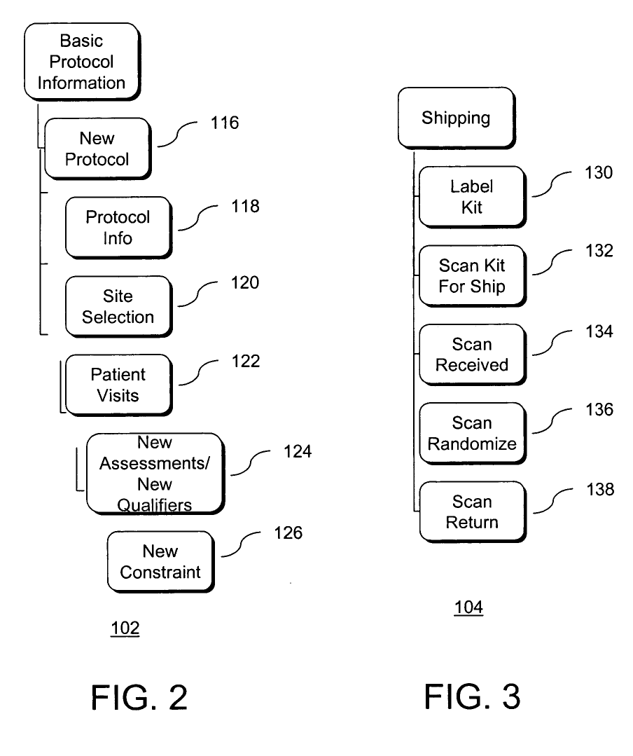

FIG. 2 depicts the BPI aspect 102. The BPI aspect of the program allows technicians to enter in all of the information and parameters that differ within each study protocol. This portion of the program is essential to the rest of the program. Allowing an administrator to enter in new protocol 116 information this way, promotes the usefulness of the data. This aspect of the program saves a tremendous amount of time as compared to manually entering data into a database.

The BPI portion 102 should provide warning screens indicating incorrect entries and empty fields. A document will be provided indicating verification that is industry specific.

The Protocol Information 118 includes Protocol Number, Name, Investigational Product, Authorized user and Contacts, and other parameters that are used later in the program to schedule patients and indicate the current visit.

Sites are selected 120 after the protocol has been established. This aids the program in printing reports, tracking patients, and tracking site progress.

Patient Visits 122 indicate what assessments will be performed at each visit. This will be used later in the program to access each patient at each visit. Patient Visits also aid in printing reports and is one of the most important parts of the program.

This allows the user to enter in New Assessments for the patient visits and New Qualifiers 124 for the patient screening visit.

This allows the user to enter a new constraint 126 amount for a New Assessment entered.

FIG. 3 depicts the Shipping aspect of the program. The Shipping aspect 104 of the program allows the Pharmaceutical Company to track all drug kits. The Pharmaceutical Company will be able to track a drug kit to a specific Site and to a specific Patient. Labels will be created for each Kit and each kit will be scanned by the system before leaving the Pharmaceutical Company, upon arrival to the Site, and when it has been selected by the Randomization process. The Label that is created will be used to indicate to the Study Coordinator which Kit to use when the Patient is Randomized.

At the Pharmaceutical Company, each Kit is labeled 130 so that it can be tracked.

At the Pharmaceutical Company, each Kit is scanned 132 before it is shipped so that the tracking process begins. The Kit is then shipped to the correct Site.

At the Site, each Kit is scanned 134 as received into inventory when it arrives at the site. The Kit is then made available for selection in the Randomized Process. The Pharmaceutical Company can access queries based on which Kits have been received.

When the Kit is selected in the Randomization Process the Kit is scanned 136 as selected and removed from the selection process. It is removed from inventory and is not available for any other Patient to use. The Kit is then used in the study. The Pharmaceutical Company can access queries and reports based on which kits have been randomized and are being used in the study.

After the study is completed the used and unused Kits are returned to the Pharmaceutical Company. The Pharmaceutical Company scans 138 the returning Kits and the results are logged in the database.

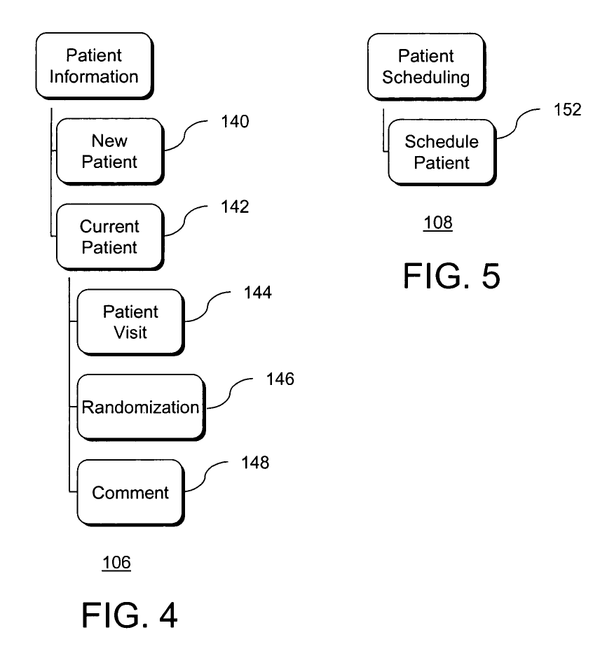

FIG. 4 describes the Patent Information portion 106 of the present invention. The Patient Information portion of the program allows sites to conduct patient visits and record the data automatically while working with the patient. Each site will have a bar code scanner, which will be used to scan each patient into the database upon arrival. During the visit, each doctor/investigator will be able to record their findings on a handheld device that is related directly to the program. This device will provide current patient information and the assessments needed to complete the current visit.

After the patient is enrolled and has returned for Visit 01 the program automatically prompts the user to Randomize the patient, if this is required by the current protocol. A direct line will be opened to the main database server and the patient will be randomized. A randomization number and corresponding kit number is assigned to the patient.

The New Patient screen allows a user to enter a new patient 140 with information such as: Initials, Date of Birth, Race, and Gender. This section also includes a Medical History portion. This information can be accessed at a later date to query for patients that might qualify for upcoming studies. The new patient is then related to a specific protocol. At that point the user can perform the screening visit or enter another new patient. The patient is then given a Patient Card that identifies them with a barcode.

The Current Patient 142 can be selected by scanning the Patient Card provided to the patient, after the Patient Information has been entered to start the Visit process. When the Current Patient is established the Patient Visit begins.

The Patient Visit 144 allows the user to enter the assessment results for each assessment during the current visit. This will be done with a hand-held device. The device will be used by the doctor/investigator to select a range or enter data for the assessment result.

At Visit 01 the user is notified automatically that the patient must be randomized 146 (if required by the protocol). A direct line is open to the main database server and the patient is randomized by the program. A randomization number and kit number are provided to the investigator. The Kit is then scanned and related to the current patient.

Each Assessment can be commented on 148 by the user while the assessment is being performed.

With the present disclosure, patients will be scheduled for their next visit upon completion of the current visit. The block diagram of FIG. 5 shows patient scheduling 108. Parameters including window of negative days, window of positive days, number of visits, and number of weeks are used to determine the days available for the patient's next visit. The correct time frame is presented to the user to show the available dates the patient visit can occur according to the protocol parameters. Then the patient is scheduled 152 within that time frame.

After the current visit is complete and the patient is leaving the office they are scheduled for their next visit using the time frame made available by the program.

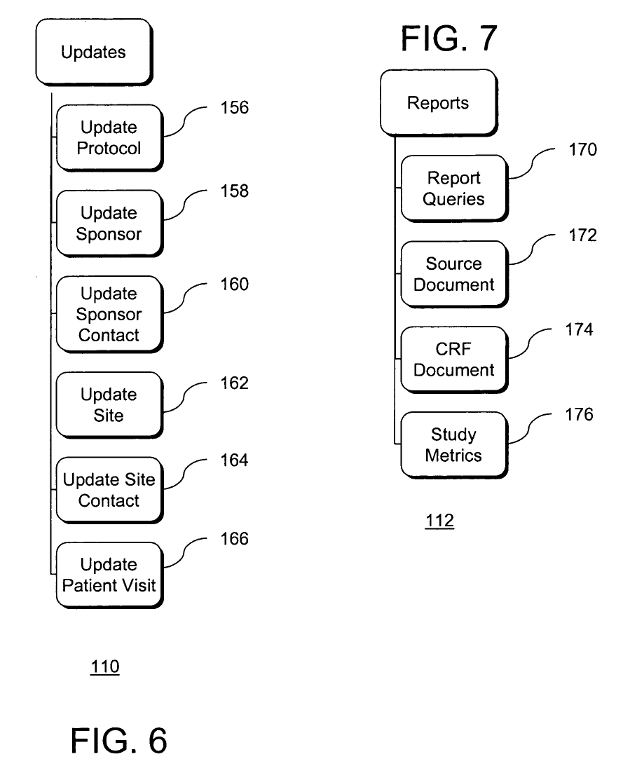

FIG. 6 shows the Update aspect 110 of the present disclosure. With the present invention, each element of the study can be updated. This is very useful to provide the user a way of changing the protocol to reflect amendments, changing addresses, phone numbers, and correcting patient visit information.

The Protocol can be updated 156 to reflect changes in the name, parameters, and other information. Sites can be related to the protocol and patient visit assessments can be changed according to protocol amendments.

The Authorized user's address and contact information can be changed 158.

The Authorized user contact phone, fax, and name can be changed to reflect any changes 160. New contacts that are related to the authorized user can also be added here. They must be related to a protocol after they are added.

The Site address and contact information can be updated 162 to reflect changes within the site. Contact information cannot be changed but a different contact can be selected. The Contact information is updated in the Update Site Contact Section.

The Site Contact information can be updated 164 to reflect any changes to phone number, fax number, and name changes.

Updating the patient visit 166 to reflect changes or correct mistakes made in the assessment is very important. This screen allows the user to return to the patient visit and make any necessary changes. All data including the old data will be stored in the database. The changes will be time and date stamped and attributed to the current user.

The present invention also includes a Reports aspect 112, as shown in FIG. 7, which provides all the information from the study at the fingertips of the user. The Reports aspect will allow users, including site personnel, authorized user personnel, and technical personnel, to generate reports based on queries. Each user will be able to generate reports based on their needs. This part of the program is very important because by using a computerized system, mistakes are easier to locate, change, and prevent.

Queries can be made to satisfy any questions presented by the party. Source Documents and case report form (CRF) documents can be seen on the screen before printing to make sure that all the information is current and complete. This will reduce the time needed to correct reports later in the study. Queries can also be created and updated quickly from the main server by request.

All of the reports can be created to look specific to each protocol or Pharmaceutical Company.

Report Queries 170 can be made by any user to locate information to answer questions about study metrics or check any data discrepancies. They will also be used to provide information to Clinical Data Management.

Source Documents 172 can be printed for each patient and kept in the patient folder. Source documents can be printed for each protocol, each site, a single patient or a single visit.

CRF Documents 174 will be printed for each patient and kept in the regulatory binder. CRF Documents can be printed for each protocol, each site, a single patient, or a single visit.

Study Metrics 176 are provided to be sorted by protocol, site, or patient.

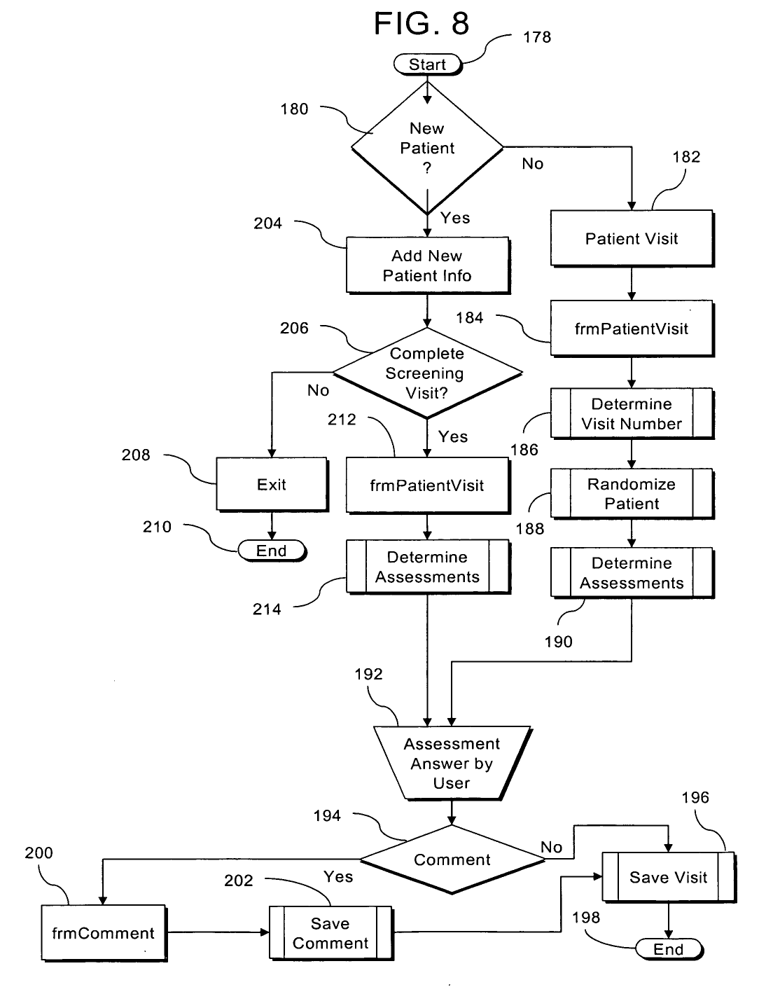

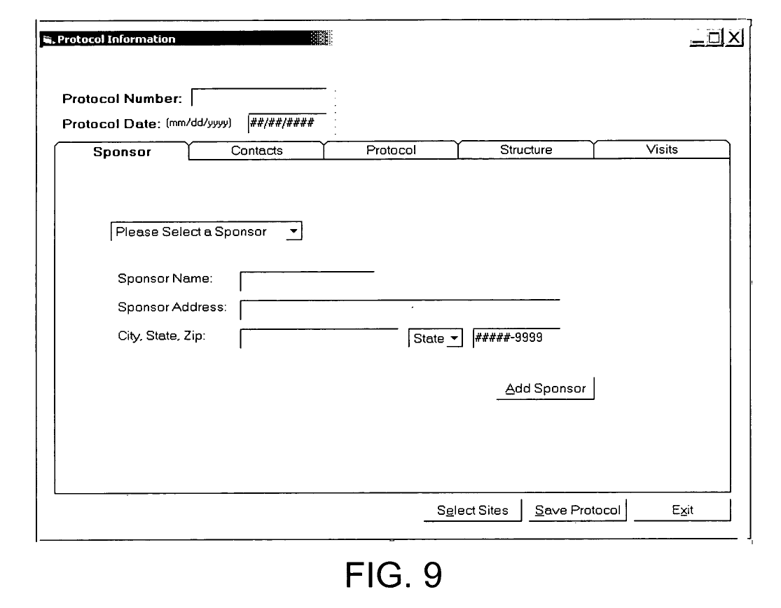

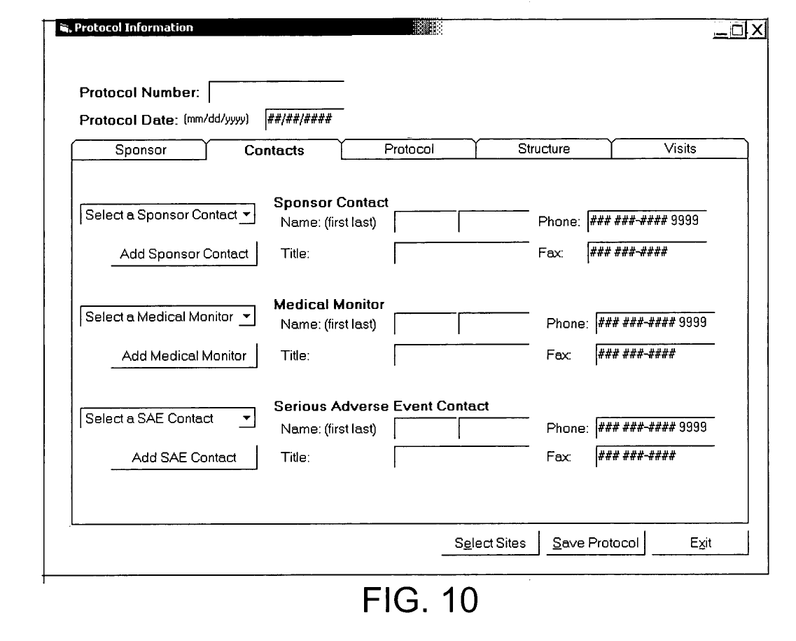

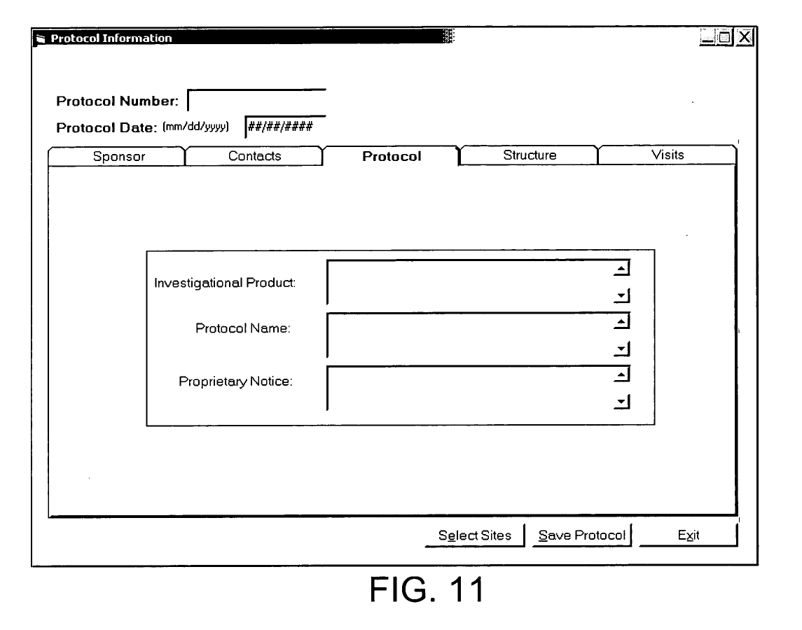

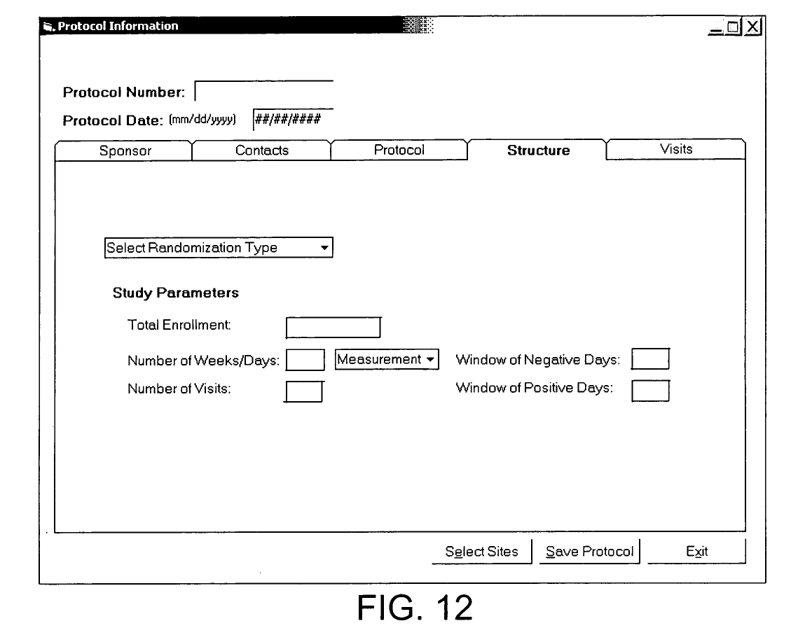

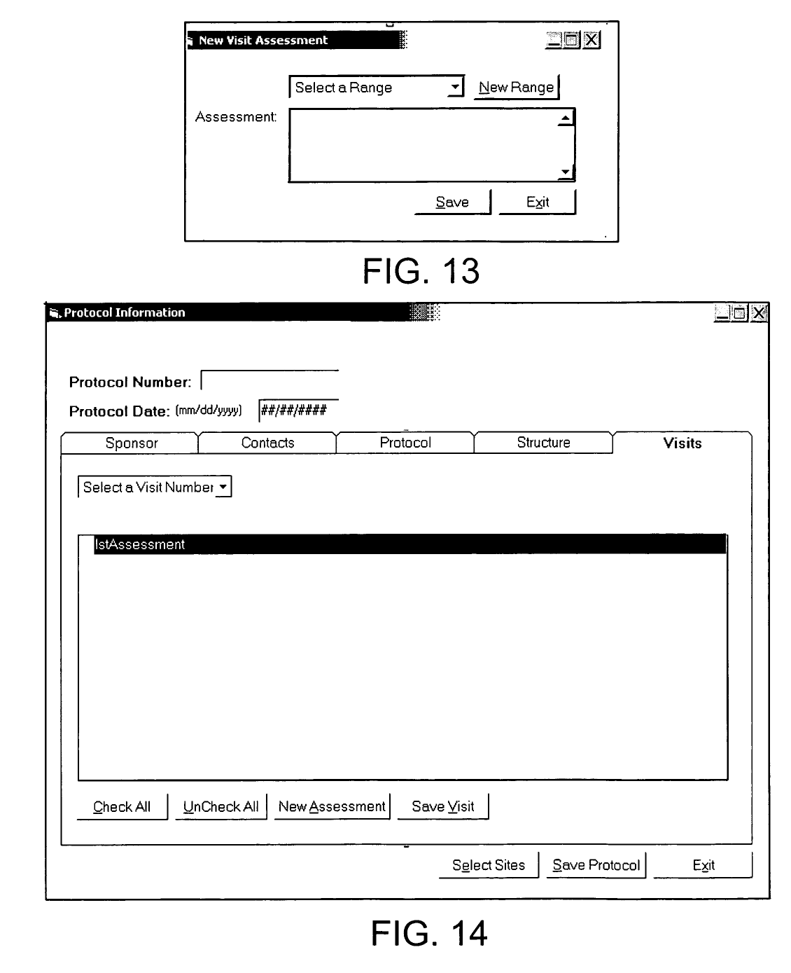

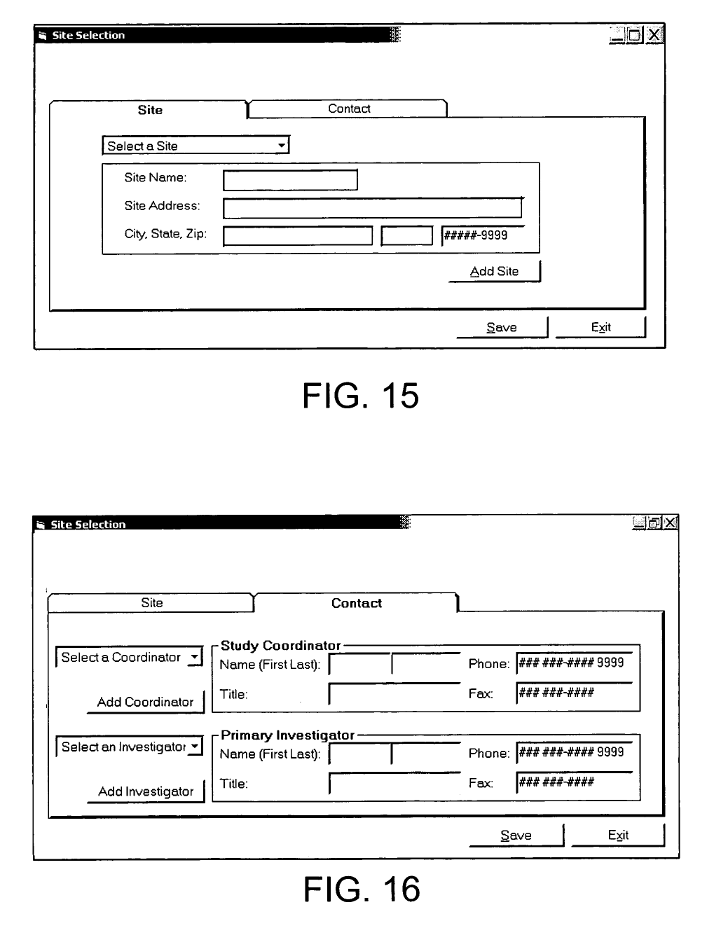

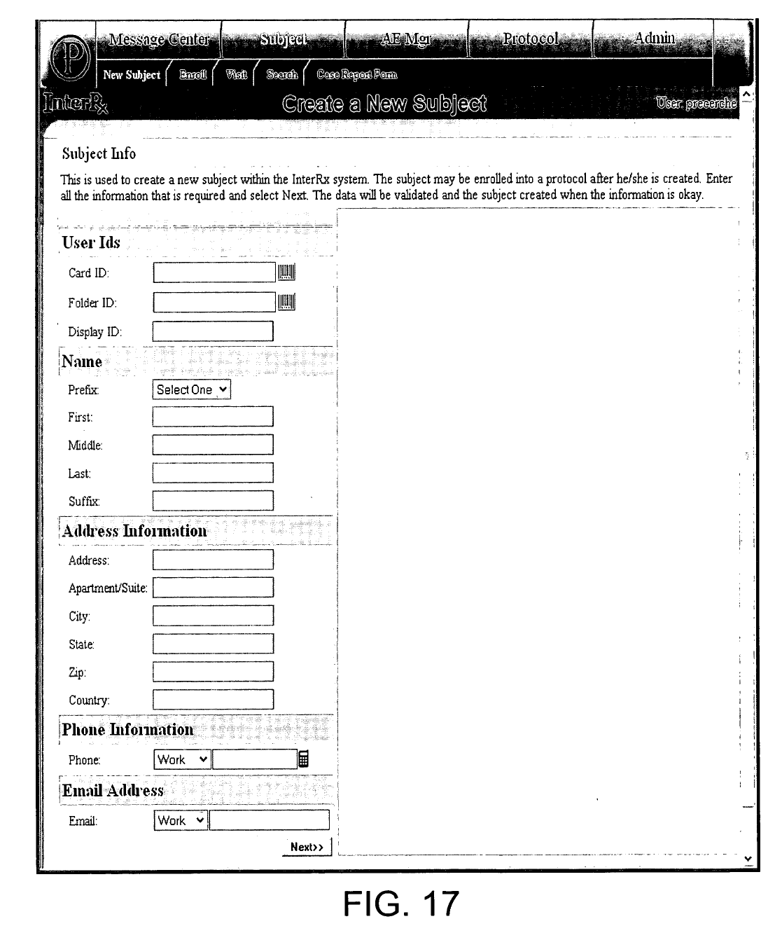

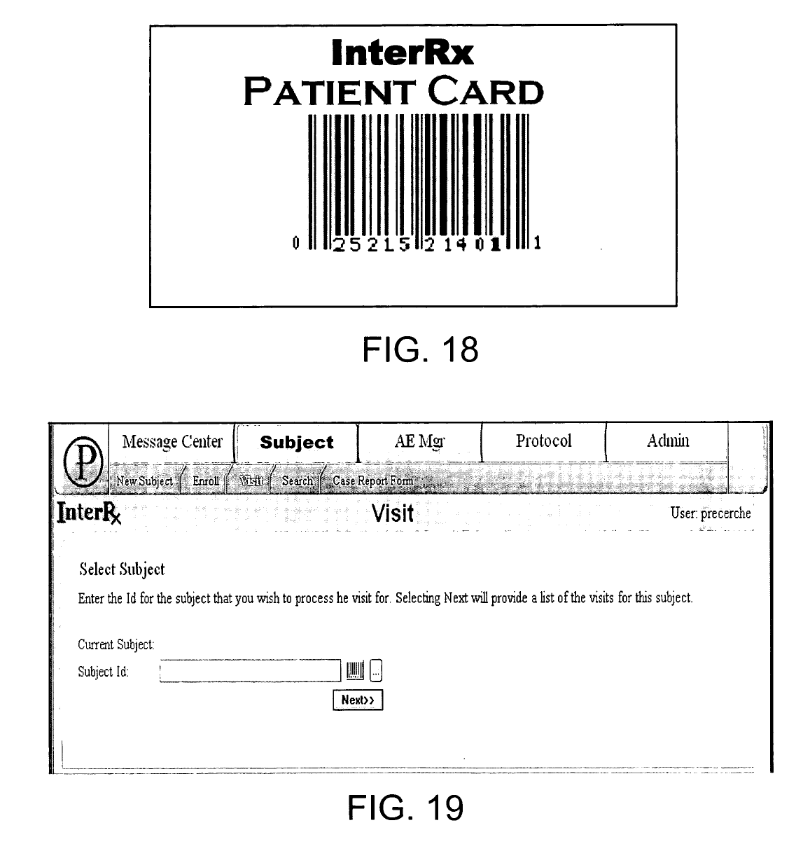

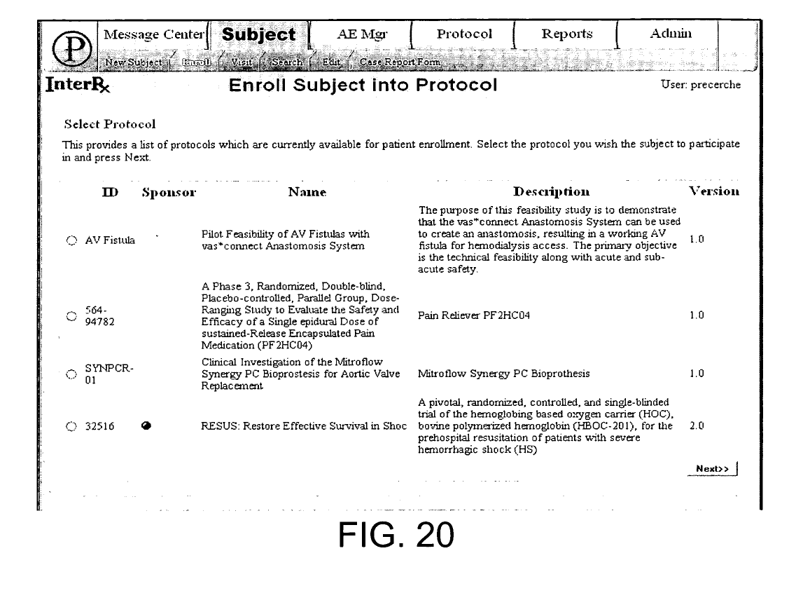

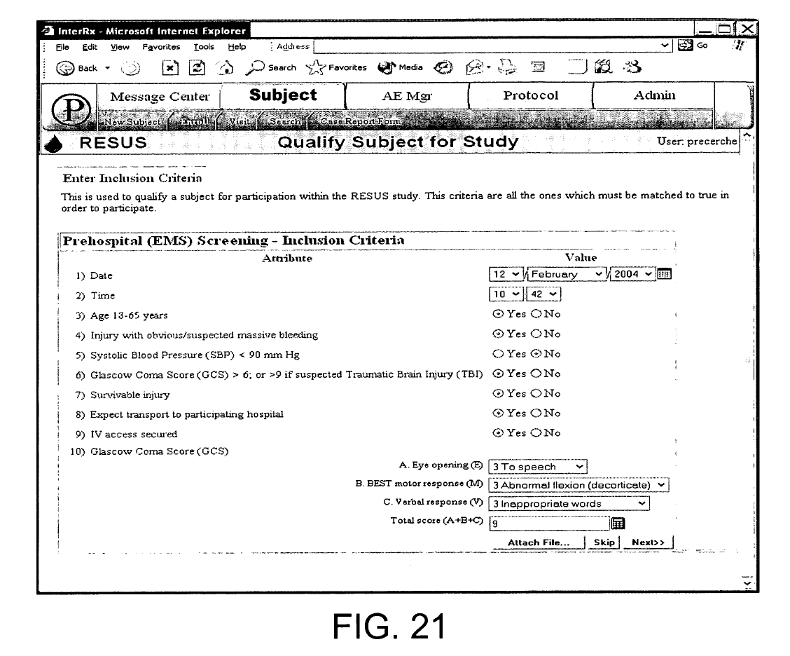

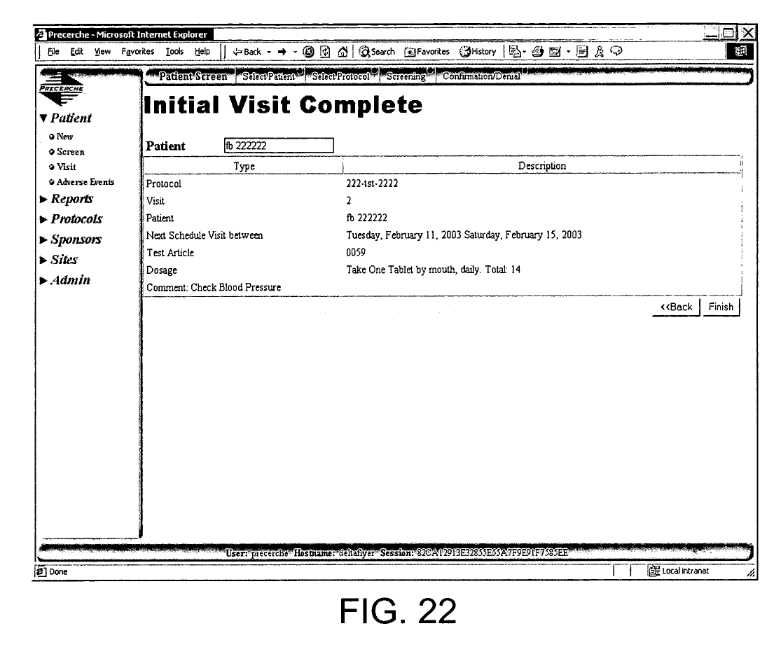

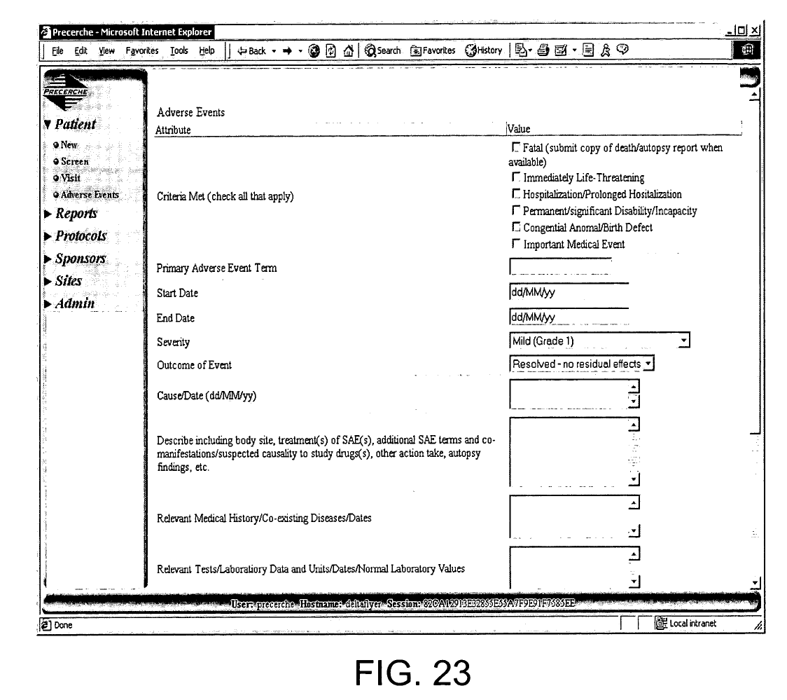

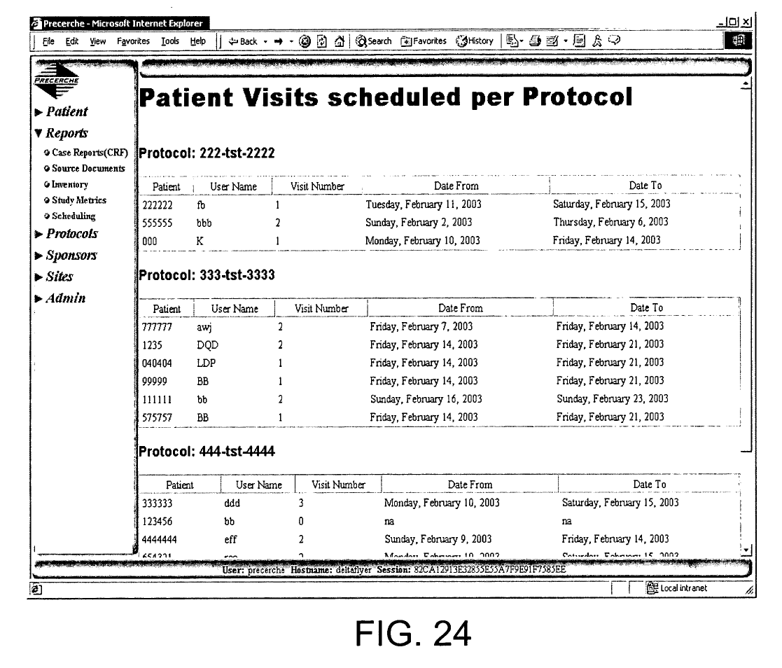

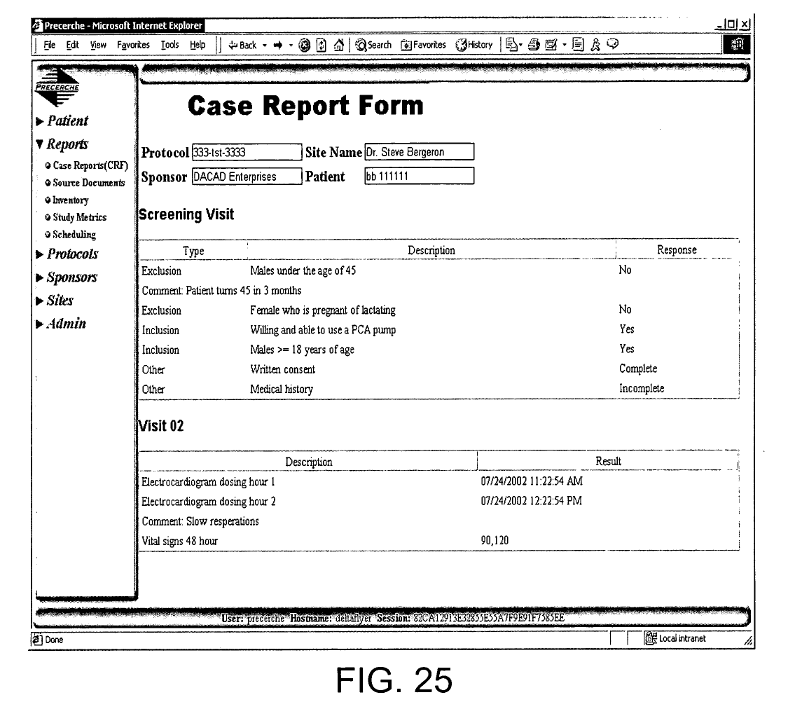

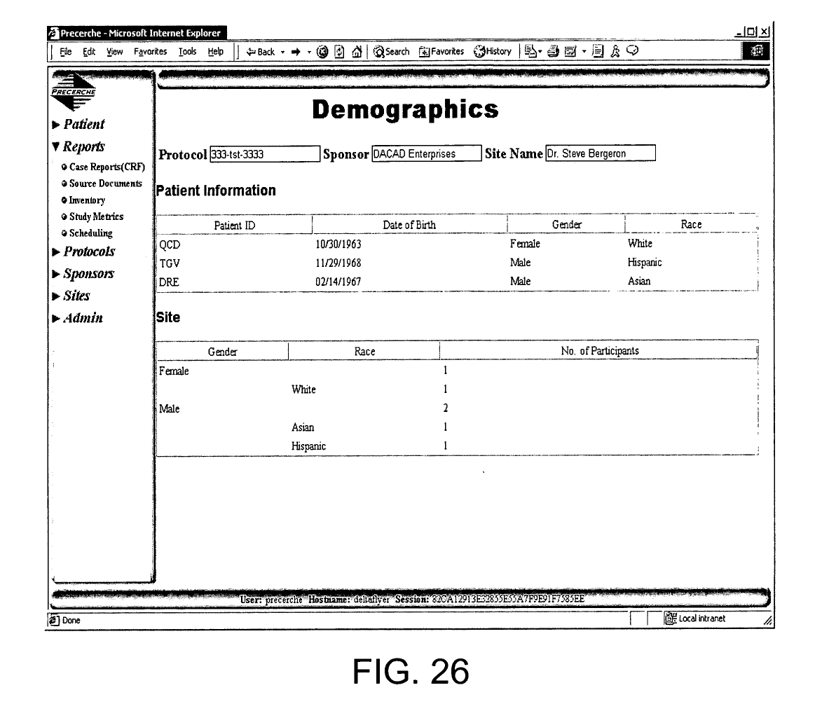

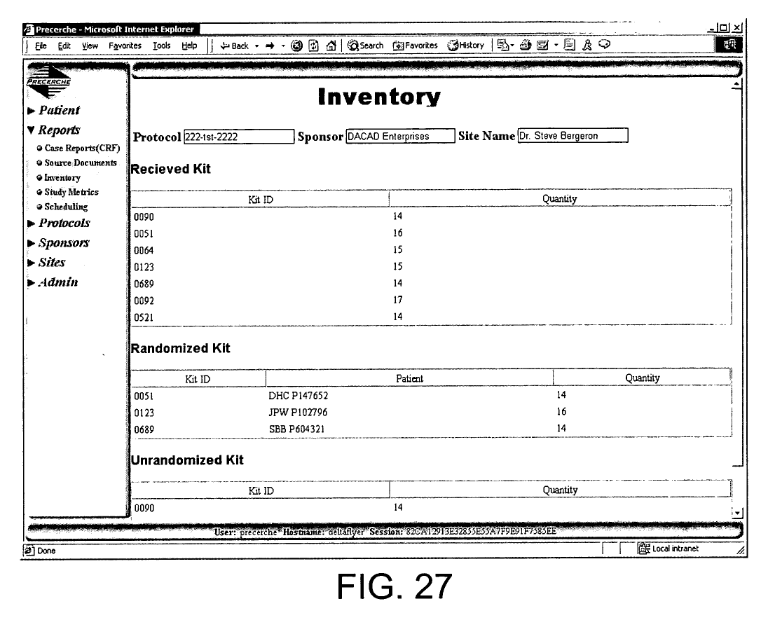

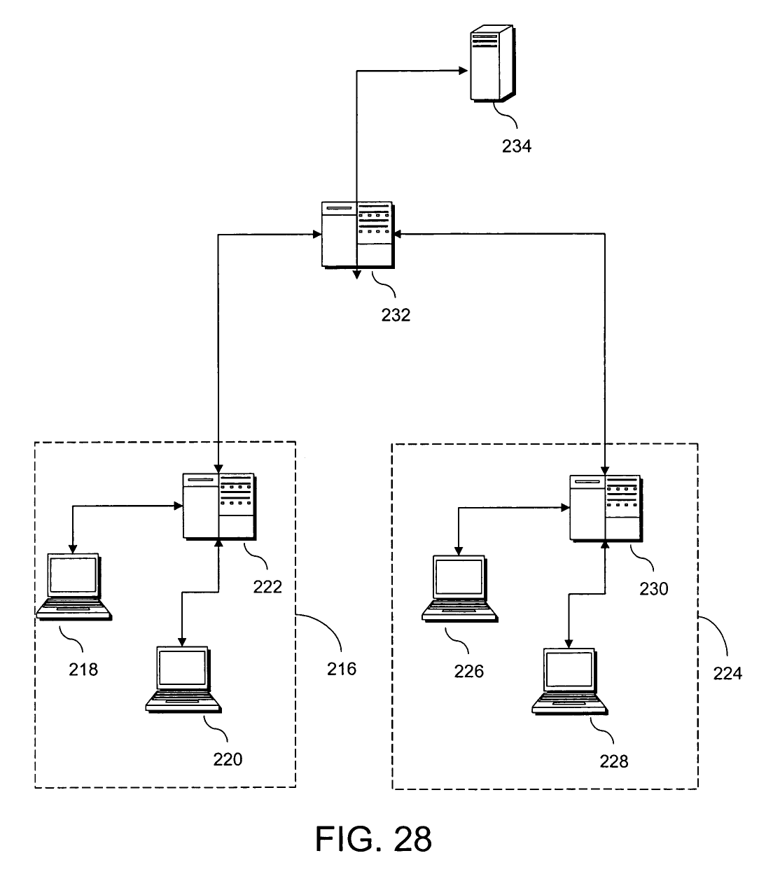

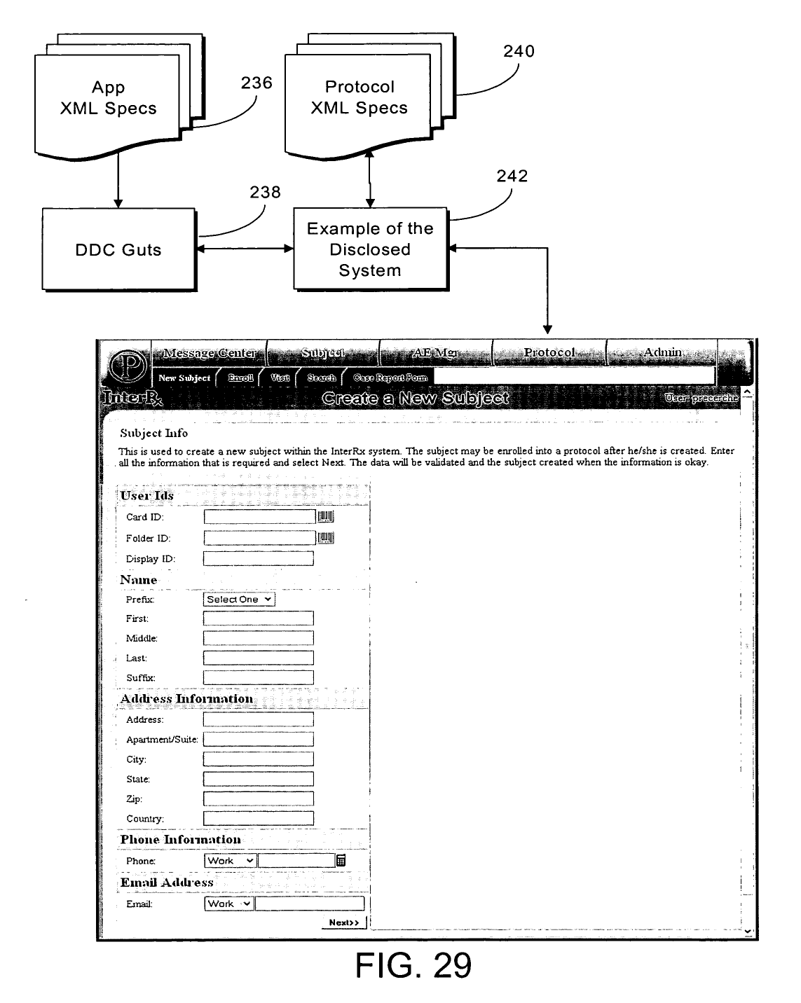

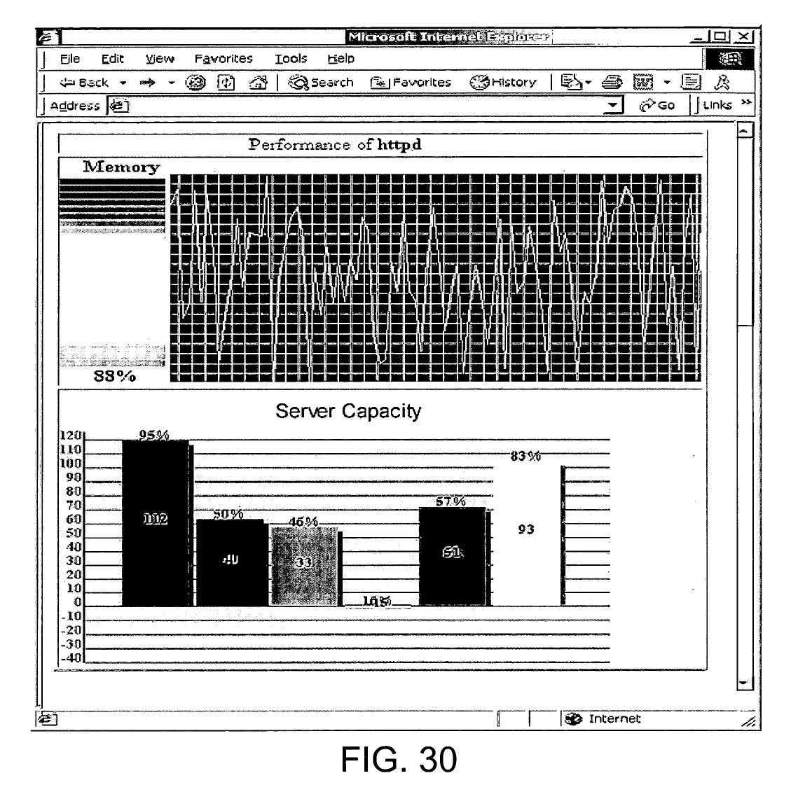

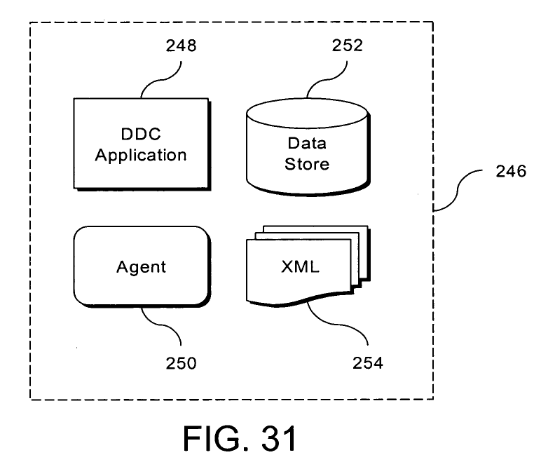

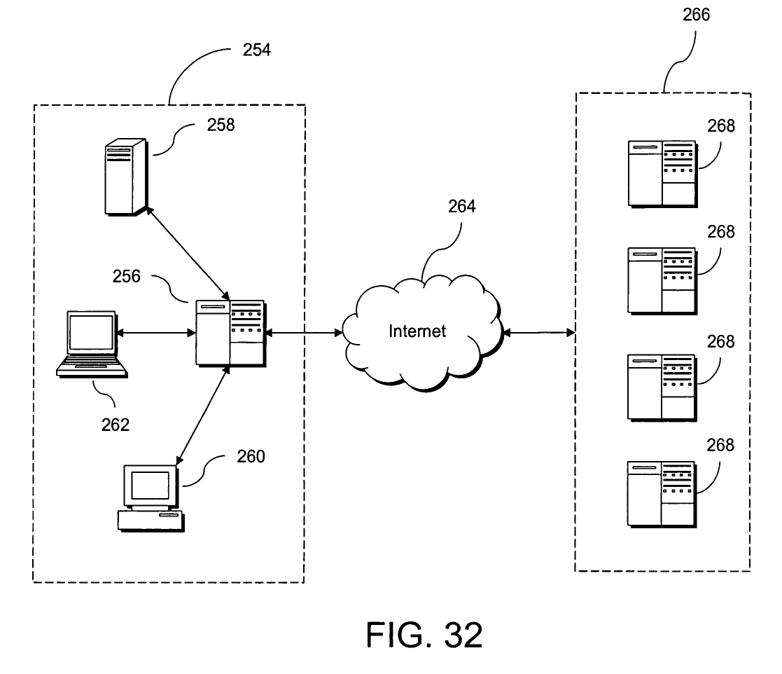

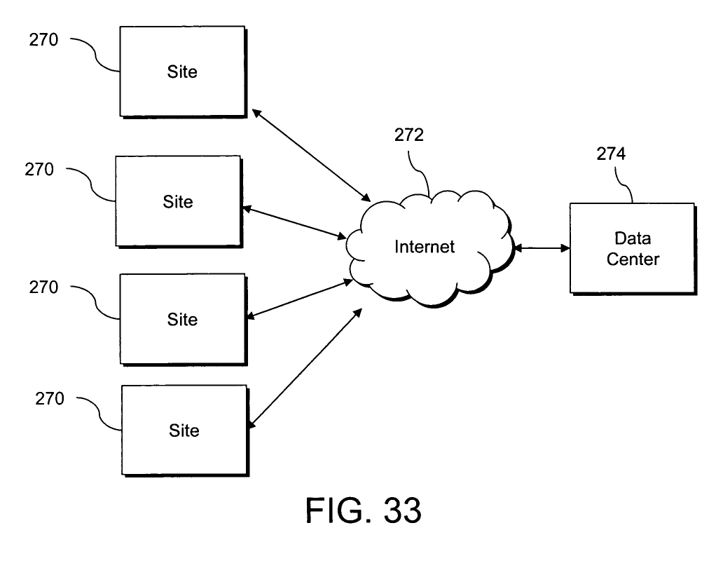

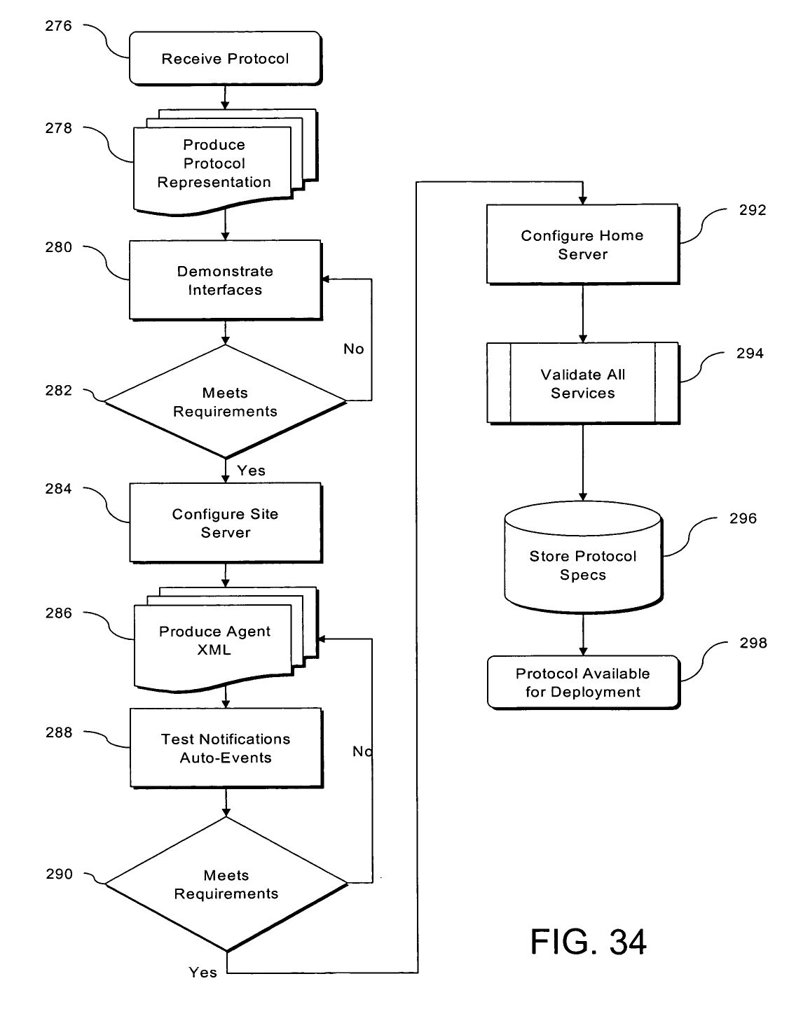

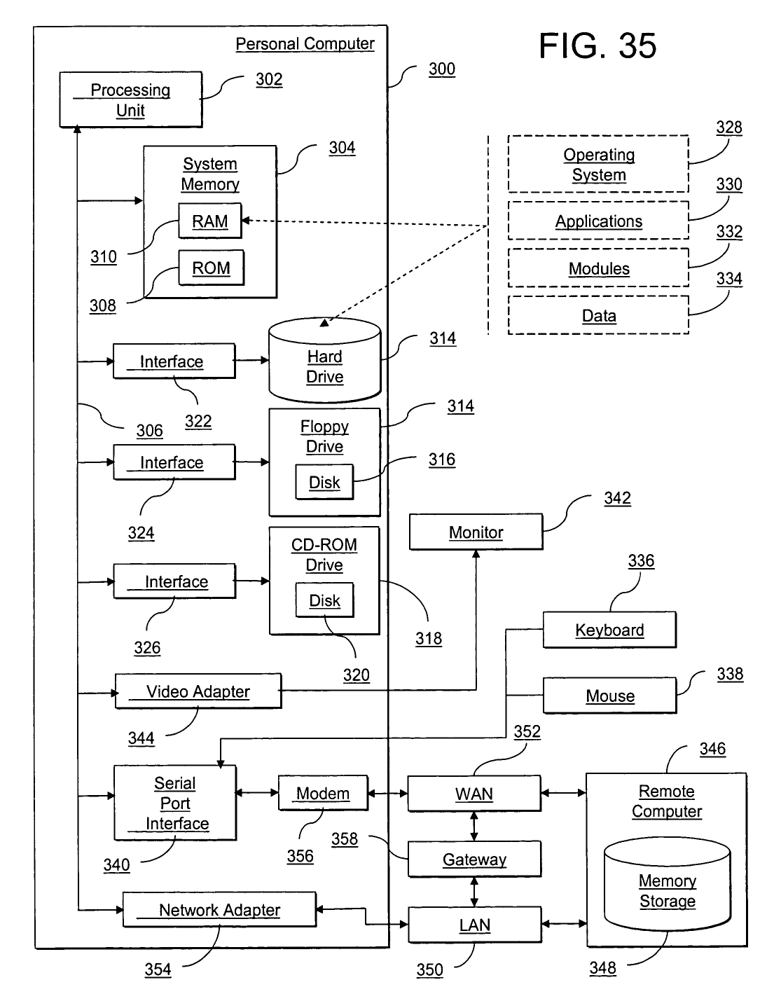

Through the use of the program of the present invention, there is the ability to perform a novel type of patient visit, which follows a flow using the technical advantages and features herein provided. FIG. 8, below shows a process flow diagram depicting one such patent visit.

FIG. 8 starts at step 178. Flow forks at step 180. If the patient is not a new patient then the patient visit occurs 182, including frmPatientVisit 184. The visit number is determined 186. The patient is randomized 188, and assessments are determined 190. User provides an assessment answer 192, followed by another fork step 194. If the user chooses not to comment, then the visit is saved 196 and the process flow ends 198. If the user does comment, frmComment 200 is used, the comment is saved 202, the visit is saved 196, and the flow then ends 198.

As shown in FIG. 8, if the patient is a new patient, then the patient information is added 204, and a decision 206 must be made as to whether a complete screening visit occurs. If not, then the flow is exited 208 and ends 210. On the other hand, if decision 206 indicates a complete screening visit, then frmPatientVisit 212 is used, assessments are determined 214, and the user provides an assessment answer 192. At that point, flow continues from step 192 as described above.

Thus, the three User decisions are whether the patient is new 180, whether to complete the screening process 206, and whether to comment on the completed screening process 194. A personal computer or hand-held computing device can be used to collect information via the frmPatientVisit and frmComment processes.

Now that the program aspects of the present invention have been explained, the following description presents more a detailed review of the user interfaces and related functions performed by the present invention.

### BASIC PROTOCOL INFORMATION

The Protocol Information includes, Protocol Number, Name, Investigational Product, Authorized user and Contacts, and other parameters that are used later in the program to schedule patients.

The Authorized user Information Interface appears in FIG. 9. The user can select an authorized user that is already in the database.

The Contact Information Interface appears in FIG. 10. The user selects contacts. Contacts that have been used before and are related to the chosen authorized user are made available to select or the user can create a new contact. The created contacts are then related to the chosen authorized user.

The Protocol Information Interface appears in FIG. 11. The product name, protocol name and the proprietary notice are entered here. These names are usually very long paragraphs.

The Structure Information Interface appears in FIG. 12. First the user selects a randomization type if the study is randomized. The Authorized user will provide the formula for the type of randomization used in the study. This will then be programmed in to be used in the study. It will also be available to be chosen for use with other studies. Second, the user will enter the study parameters. These parameters are used to monitor the study and send out alerts. The total enrollment is the total number of patients/subjects the study requires. It gives the enrollment a stopping place and allows metrics to be given on different parts of the study, such as percentage of enrollment each site has or an anticipated time of enrollment ending. The number or Weeks/Days/Months is the number of total Weeks/Days/Months in the total study and helps determine when each visit occurs. Window of Pos/Neg days are used in the SCHEDULING part of the application where applicable. A patient/subject must complete their visit within this time period. These numbers will alert the scheduler of the proper calendar days available for the patient to make their visit.

The Visit Information Interfaces appear in FIGS. 13 and 14. The user selects a visit number (Screening Visit, Visit 01, Visit 02) and then checks off the selections (assessments) that must be done at that visit. If the selection is not available the user will select New Assessment and a new window appears to enter the Assessment: The user selects a range (i.e., Complete:Incomplete, 0 to 100, Yes:No). If the desired range is not available a New constraint is created. The user clicks on New constraint and a window appears that has a text box to enter constraint data and shows some examples. When the user saves the constraint data it goes back to the New Visit Assessment Window. The user then enters the New Assessment and Saves. The program returns to the Visit window and the New Assessment is already checked off for the user. After all the Assessments have been selected the user saves the current visit and repeats the process for the next visit.

Select Sites and Contact Interfaces appear in FIGS. 15 and 16. The user can select a Site that is related to the chosen Authorized user or create a new site. The user can select a Contact that is related to the chosen Site or create a new Contact. After the Contacts are selected the user saves the selection. There are multiple sites for each protocol.

After the user has completed all of these tasks the Protocol Information is saved. Everything for the protocol Information is updateable. Contacts usually change and this information is very important. If enrollment is low then Inclusion/Exclusion Criteria can change as well.

### PATIENT INFORMATION

Any use of the program will be date/time stamped with the available UserID. The Patient Information Interface appears in FIG. 17. The user enters all the Patient Personal Information (Address, Phone, DOB, and Medical History). This information is stored to allow the Site Users (Investigator and Study Coordinator) access to patient information and medical history. Users can search criteria to find patients that might qualify for future studies. Patient Barcode for use with the present invention appears in FIG. 18. The Patient's card is matched with their information and the current Protocol they are participating in. A card (with barcode) is given to the patient and one is placed in their chart. It will be logged with each visit which card is being used to scan the patient in to prevent fraud.

The Screening Visit Interface that appears in FIG. 19 is then preformed using the Assessments for that visit. The Visit occurs before the patient is enrolled in the study to make sure they pass all the criteria determined.

First the Patient is selected using the Bar Code Scanner and the Patient Card. Second the Protocol (study) the patient is being tested for is selected through the interface of FIG. 20. This indicates to the program which set of assessments (questions) the patient should be judged against.

The Screening Visit Assessments are then shown on the screen appearing in FIG. 21 and the actual screening of the patient begins. The program then indicates on the interface of FIG. 22 all of the current answers to the user so they can be checked for errors. If the patient passes the screening visit the program indicates that the patient has been confirmed and they are enrolled in the study. The program also indicates the time the next patient visit should occur according to the scheduling parameters of the current protocol.

The Patient Visit Interface appears in FIG. 23.

In the Scan the Patient step, the program recognizes the Protocol, Patient, and the Current Visit when the Patient Card is scanned by the Bar Code Scanner.

In the Assessments step, the Assessments for the current Visit are then preformed. This screen will basically look the same as the above Screening Visit Assessments.

In the Randomization step, during the Visit 01 the patient will be randomized and a Drug Kit will be indicated by the program to be used for the Patient. The Drug Kit used is determined by the Inventory part of the program and the Randomization part of the program. Not all studies are Randomized.

An Adverse Event (AE) is a situation where something such as death or a side effect has occurred during the study. If an Assessment Question is answered to indicate an adverse event the user is automatically prompted to begin filling out the adverse event form for the current patient. The User can also begin this process by selecting adverse events from the menu and scanning the current patient bar code. After this form is completed the user is notified by email to complete the follow-up Adverse Event form.

Patient Scheduling Interface FIG. 23 appears below. After each visit the Patient's next visit is scheduled using the calendar dates provided by the program. These dates should be within the Protocol Parameters that were entered in the Protocol Prophet. After each visit the User will be notified of the available dates the Patient Visit can occur according to the parameters provided from the Protocol Document.

In Patient Updates, sometimes Assessments of the Visit cannot be answered at the time of the Visit (i.e., lab work, blood work). The user needs to be able to update the incomplete visit as soon as the missing information becomes available. The update screens look like the regular Patient Visit Screens. Users will be able to update missing information. If an error is found in the data the user can change the data. The new data will be stored. Old and new data can be viewed/printed in the Source Document Report.

In the Incomplete Visit Notification step, the user should be notified by email of pending patient visits.

In the Other Notifications step, other Patient Notifications will be available to specific users.

### REPORTING

Reports are printed or looked at on screen by various users, such as appearing in FIG. 25, including Authorized users, Sites, Investigators, and Study Coordinators. Each user uses reports for different reasons including monitoring metrics and for patient charts.

In the Set Report Type step, the Authorized user provides report form and we will create reports that look just like what the Authorized user has provided. These reports include the case reporter form (CRF) and Source Document. These reports are usually sorted by Protocol, Site and Patient.

Study Metrics Reports, such as appearing in FIG. 26, provide Sites and Authorized users with information regarding enrollment, Adverse Events and other Metrics. These reports are usually sorted by Protocol and Site. These reports can be represented by graphs as well.

Users will be able to use Report Queries to query the database to obtain information on any patient, study, or anything else needed by the users. These queries will give the users choices of what fields they want in the report and how they need the report sorted. This will be a very useful tool for all of the users.

### INVENTORY

The Authorized user and the Site check inventory interface of FIG. 27 is used in the Randomization process of the Patient Visit 01 and for Reporting. The Authorized user User scans Drug Kits to be sent to a certain Site. The Site marks the Drug Kits as received. Once the Drug Kits are received they are available for use in the randomization process. The Authorized user can then detect what Drug Kits have been used and which ones are still on the shelf at the Site. Inventory will be expanded later to include testing supplies and other medical supplies.

FIG. 28 shows example of a system according to the disclosure. A site 216 includes a site server 222, and two computing devices 218, 220 communicably coupled to said server 222. The computing devices 218, 220 are of the type useful for data capture, such as tablet PC's or notebook computers. Another site 224 is also shown which includes a site server 230 and two data gathering computing devices 226, 228. Each site 216, 224 includes intuitive electronic data capture (EDC), printing, scanning, and inventory management functionalities.

FIG. 28 also shows the sites 216, 224 communicably coupled to a central server 232 including a dedicated server, source documents, patient data, study metrics, and full audit trail. Any number of sites such as sites 216, 224 can be included in the system of FIG. 28.

Also shown in FIG. 28, the central server 232 is shown to be communicably coupled to an authorized user's computing device 234. The authorized user's computing device thereby gains access to “same day” reports, trial management, online monitoring and audits, and inventory management.

The following table shows the potential financial impact of implementing the preferred embodiment of the present invention.

Financial Impact

| | Paper | Disclosed System | Savings |
|---|---|---|---|
| Direct Cost | $5-9M | $3-5M | $2-4M |
| Time (months) | 12-30 | 6-15 | 6-18 |

Time to Market Benefit = $10 + million

The disclosed system is the only total solution for clinical study management of which the inventor is aware.

The disclosed system's capabilities include intuitive electronic data capture (EDC), trial management, inventory management, monitoring & auditing, security and compliance, “same day” reporting, agile framework, and is a turn-key solution.

Intuitive EDC features include easy-to-use tablet PC's; scanned source documents; add, screen & view patients; the disclosed system enforces all protocol parameters; and immediate error-checking reduces queries.

Trial Management includes a message center, query submission & resolution, view protocol definition, exception requests & approvals, and staff management.

Inventory management includes barcode scan articles, tracking of inventory, and inventory shipment requests.

Monitoring & auditing includes anytime, anywhere access to: study data, metrics, queries, reports, auditing, and events.

Features making the system secure and compliant include being a closed system, HIPAA & 21 C.F.R. § 11 compliance, user administration and authorization, encrypted transmissions, firewall protection, and a fully redundant distributed database architecture with dedicated servers.

“Same day” reporting includes CRF forms, electronic and scanned source documents, study and site metrics, AE/SAE's, queries, and automated daily reports and notifications.

Features making the system's framework agile include a proprietary architecture which enables rapid implementation and change propagation; XML specifications that define the disclosed system application, the protocol and CRF forms, and the user interface, reports, and tasks; and its fully customizable nature.

Features making the system a turn-key solution include the disclosed system being configured to a selected protocol, exploitation of mobile tablet PC's with barcode scanners, use of site servers and a central server, use of printers and document scanners, availability of installation and training, support, and post-trial data storage and data accessibility.

The following table illustrates the system's support for the listed steps.

| | |
|---|---|
| Solicitation | Provide interfaces for user to enter |
| | data |
| Validation | Multi-step validation of data |
| Distribution | Specifications & secure data |
| | transmission |
| Correlation | Algorithmic analysis of data, trend |
| | analysis etc. |
| Aggregation | Efficient mechanisms for storing |
| | various stages of data |
| Automation | Many components and features are |
| | automated |

The system Application is a J2EE Web application that provides “manual” hands-on functionality and data solicitation, validation and observation. XML describes task flow, including categories, tasks, steps, and branches.

The system Agent is a JMX based Java daemon that provides “automated” functionality. The Agent includes data management, dynamically extensible and configurable. XML describes rules, including conditions and responses.

The system Data Sources include generic data read/write ability: JDBC connection to standard databases such as Oracle and MySQL; input and output using XML; utilizing document files of various types; and using binary objects such as serialized Java objects.

The following table illustrates Security features of the system:

| | |
|---|---|
| Authentication | Validating the users of and by |
| | the system |
| Authorization | Access control checked at all |
| | critical junctures |
| Auditing | All actions and communications |
| | are recorded |
| Secure Data | Encryption on “signed” secure |
| Transmissions | channels |
| User Administration | Proper clearance and “need to |
| | know” established |

XML specifications are utilized in data templates (including object definitions, storage and retrieval mechanisms, and data “maps” for data conversions), presentation & validation templates (including report definitions), application tasks, and automated agent tasks.

FIG. 29 depicts transitioning from specification to study. The Guts component 238 consumes XML specification 236 to define the application of the example of the disclosed system 242. The protocol specifications 240 define the study process and data and automated tasks for the Agent to perform.

The Guts 238 component has a secure infrastructure containing basic capabilities, control functionality, and storage facilities. The basic capabilities include a task manager, a message center, a reporting engine, and any custom “pages.” The control functionality includes solicitation and validation. The storage facilities include communication, distribution, and mapping.

Reports, graphs and charts, such as shown in FIG. 30 provide visual representation of quantitative and historical analysis. Examples of graphical elements employed include tables, bar charts, pie charts, histograms, and meters.

The Java JMX daemon component has the ability to utilize management modules. Modules contain data access and functionality including system, file system, data access, and notification. System information includes processing information and resource usage (CPU, memory, threads etc). File system information includes file size, state, and manipulation (e.g., create, move, delete, zip, etc.). Data access functionality allows analysis of SQL queries. Notification functionality includes emails and SNMP.

Dynamic incorporation of “Rules” can include evaluation of conditions and execution of actions. Automated tasks can include data analysis, data distribution, notifications, and pro-active “actions.” (Referring to the above sections [0143 & 0144], is this information being patented or just referenced?)

FIG. 31 depicts a typical Dynamic Data Control (DDC) server configuration 246. The DDC server configuration 246 includes a DDC Application 248, an Agent 250, a Data Store 252, and XML 254.

FIG. 32 shows a typical home or site configuration. Site 274 is shown to include various computing devices communicably coupled to a site server 256. The computing devices include tower 258, desktop computer 260, and notebook computer 262. The site 254 is communicably coupled through the Internet 264 to data center 266, which is shown to include four home servers 268.

FIG. 33 illustrates a typical infrastructure for multiple Sites 270. The Sites 270 are communicably coupled via the Internet 272 to the data center 274. Here, and throughout this specification and associated figures, reference is made to the Internet. Wherever such reference is made, it should be understood that what is meant is any full-time, public network. The Internet is merely one such network, and is referenced for convenience, not with the intention of limiting the scope of application of the teachings of this disclosure.

The disclosed system utilizes DDC technology to create a system to manage clinical studies.

The DDC technology allows management of the study lifecycle. The system can configure XML protocol specification, deploy system & protocol specification to Sites, input and track patient information, and provide trial-time analysis, notifications and inventory tracking. In addition, the system can collect data from study locations and produce collective reports and biostats.

The system is customizable to authorized user, site and protocol parameters; event notifications and recipients; report types; and randomization methodologies.

As discussed above, the system is secure by virtue of being HIPPA compliant, international banking security grade, using secure data transmission, firewall protection, an on-site server, audit trails and message tracking, and user administration.

Protocol information includes screening, patient management, information and document management, and inventory management.

Site information can be accessed by the pharmaceutical company from the site. Such site information can include the number screened, enrollment, the number of screen fails and failure indications, withdrawals and drops, demographics, inventory, contact information, and adverse events (AEs) and serious adverse events (SAEs).

Patient information can include visits; subject information; and documents, forms and reports. Visit information can include assessment information, scheduling, and randomization and inventory. Subject information can include a medical profile and study participation. Documents, forms and reports can include case report forms (CRFs) and source documents, AEs and SAEs, and Institutional Review Board (IRB) and regulatory documents.

Inventory information can include track kit randomization, track shipping to and from site, track test article, and custom inventory management can be easily created and integrated.

Automated tasks of the disclosed system include automated agent tasks such as data uploads, protocol modification downloads, serious events notification, fraud detection, auto-reports, trend analysis, and message dissemination.

Study related reports, graphs and charts can include quantitative and historical analysis available throughout the study, AE and SAE information, study metrics and demographics, and study listings and queries.

Document management encompasses source documents and CRFs, as well as IRB & regulatory documents. Source documents & CRFs are subject to real time availability, can be accessed by authorized users, can be printed or viewed on screen, and typically queries are easily resolved. IRB & regulatory documents may take advantage of electronic data transfer and can be accessible real time.

Administrative capabilities of the system allow it to maintain a patient data base, create and update protocol information, determine the type of randomization, monitor medication and kit inventory, and view documents such as case report forms.

### EXAMPLE: PROTOCOL GENERATION

This section describes an example of a process according to the present invention that is used to create an XML representation of a Protocol (Protocol Representation). This Protocol Representation can in-turn be used as input into the disclosed system applications to the execution parameters and provide the data forms, reports, and event monitoring that are necessary to conduct the study defined by the original Protocol. One major advantage to the disclosed system solution is that when changes or modifications need to be incorporated into the study, they can be created and distributed in short order as defined later in this document. These changes are reflected in the Protocol Representation and can include additional data fields, trend analysis algorithms and even contact information for example. The following process chart will list the major steps necessary to accomplish the generation of the Protocol Representation and any accompanying information about the step.

There are some steps and processes not specified that are not necessarily part of the Protocol Generation process that can occur during the same time periods. These would include evaluation of implementation planning, cost analysis, etc.

| | |
|---|---|
| Receive | The customer provides all |
| Protocol | documents relating to the |
| | Protocol describing the study |
| | they wish to conduct. This |
| | should include Case Report Forms |
| | and all definitions of data |
| | boundaries, reports and Biostats |
| | that the study will produce. |
| | This documentation should also |
| | describe Adverse Event and |
| | Serious Adverse Event Forms and |
| | the situations that lead to the |
| | generation of an Event. |
| Evaluate | Services will examine the |
| Customer | customer's Protocol for any |
| Protocol | issues and/or inconsistencies |
| | that may result when the |
| | Protocol is transformed into XML |
| | specifications. |
| Produce | Services will take the submitted |
| Protocol | Protocol and generate XML |
| Representation | documents that describe tasks, |
| | data entry forms, validation |
| | tests, reports, event |
| | notifications and all other |
| | pertinent information that will |
| | be utilized by the disclosed |
| | system applications to conduct |
| | the study. *NOTE: The basic |
| | protocol information (BPI) |
| | aspect can be used for creation |
| | and modification of the Protocol |
| | Representation. |
| Demonstrate | Using the Protocol |
| Interfaces | Representation, on-site or on- |
| | line access will be provided to |
| | examine the forms and reports |
| | that were developed for the |
| | disclosed system. The customer |
| | can “try-out” the interfaces and |
| | view examples of reports that |
| | will be available during the |
| | study. Modifications can be made |
| | until the customer is satisfied |
| | that the Protocol Representation |
| | is ready for deployment. |
| Protocol | Once the Protocol XML |
| Representation | Specification (Protocol |
| Validation | Representation) is complete, |
| | access to the interfaces will be |
| | made available to a customer |
| | representative via the Internet |
| | that will be used to co-validate |
| | that it has been implemented |
| | properly and that they meet the |
| | customer's requirements. |
| Protocol | The disclosed system |
| Representation | Application, in implementing XML |
| Stored in | specifications, includes several |
| Corporate | major blocks of processes (see |
| Server | sections 6-10 in the flowchart). |
| | These looping processes ensure |
| | that each function within XML |
| | processing is checked for |
| | function and accuracy. If |
| | changes are necessary, the |
| | specification is adjusted and |
| | retested until no further |
| | changes are necessary. It is in |
| | this manner that checks and |
| | balances occur throughout the |
| | processes and the final |
| | application is tested “end-to- |
| | end” throughout the systems. |
| Validate | Working with the customer, |
| Interfaces | Services provide available |
| | modifications or customizations |
| | to the interfaces. |
| | Once the customer agrees with |
| | the interfaces and all the legal |
| | and financial issues are |
| | addressed. |

### EXAMPLE: BASIC PROTOCOL INFORMATION

The basic protocol information aspect (BPI) has been described above in relation to FIG. 2. The BPI is an Internet based graphical tool that is used to take an authorized user Protocol and create XML specifications (Protocol Representation) that the disclosed system uses to provide interfaces and functionality necessary to conduct the study defined by the Protocol. The BPI is a wizard-based application that guides the user through the steps that are necessary to create the Protocol Representation. A portion of the BPI will allow the user to view the results of their work at any time in the process. Intermediate versions (or drafts) of the Protocol Representation will be made available as well as the completed ones to authorized users. The following explains the basic steps and abilities that are involved in creating a Protocol Representation using the BPI. The process chart defines the methodology for using it.

| | |
|---|---|
| Enable BPI | Since the BPI is an internet-based |
| | application, enabling it will |
| | involve using the user's internet |
| | browser of choice and then going to |
| | the Internet Address that provides |
| | the BPI. |
| Enter Base | The User will be queried to enter |
| Protocol | “base” Protocol information such as |
| Information | the type of study, name of the |
| | Protocol, the Authorized user's |
| | Information, Protocol ID, and other |
| | information that is standard for |
| | Protocols. |
| Design Case | The BPI provides the User with the |
| Report Forms | ability to dynamically create Case |
| | Report Forms, or a series of “Data |
| | Collection” forms, which have data |
| | items such as “Heart Rate:” etc. |
| | that will allow the end-user the |
| | ability to input data. This for |
| | example, allows the user to define |
| | “constraints” for each data item |
| | which provides such checks as |
| | Is a value required |
| | Min Value |
| | Max Value |
| | Many values and constraints will be |
| | available from a selectable list. |
| | The list is of “known” data items |
| | that are common within various |
| | studies. |
| Review | The BPI has the ability to display |
| Interfaces | any of the categories of information |
| | used for a study, including Sites, |
| | Visits, Inventory, and Reports. The |
| | user enables the list of the |
| | particular items that they wish to |
| | view and selecting one of the items |
| | will produce and example of the |
| | desired item. The user can then make |
| | specific modifications at any time. |
| Define | Authorized user information will be |
| Authorized | kept for the Authorized users that |
| user | have conducted studies with the |
| | disclosed system. The BPI will |
| | provide the ability to select |
| | “known” Authorized users and |
| | information about the Authorized |
| | user will be pre-loaded into the |
| | Authorized user information for |
| | rapid development. The user can |
| | update the information or can enter |
| | a new Authorized user and determine |
| | whether the new Authorized user |
| | should be made available as a |
| | selectable entity. |
| Define Sites | Site information will be kept for |
| | the Sites that have conducted |
| | studies using the disclosed system. |
| | The BPI will provide the ability to |
| | select Sites and information about |
| | the Site will be pre-loaded to save |
| | time. The user can update the |
| | information or can enter a new Site |
| | and determine whether the new Site |
| | should be made available as a |
| | selectable entity. |
| Define Reports | There are several “standard” report |
| | types that are available within the |
| | BPI. Once selected these reports |
| | will be made available by the |
| | disclosed system for the end-user to |
| | view. In addition, a custom |
| | reporting tool is available which |
| | will allow the user to define |
| | reports built from data that is |
| | available from the disclosed system |
| | and the data items that have been |
| | defined within a specific Protocol |
| | Representation. Drop-in Custom |
| | reports which are outside the scope |
| | of standard information which |
| | involve correlation or other types |
| | of algorithms to produce can be |
| | integrated into the Protocol |
| | Representation view this |
| | functionality also. These are |
| | reports are self-contained and only |
| | need a reference to be accessible. |
| | This can provide reference to those |
| | types of reports as well. Also, the |
| | user can select the Roles of those |
| | end-user's that will be allowed to |
| | view the report. |
| Protocol | BPI can perform a “final-check” |
| Verification | verification on the Protocol |
| | Representation to make sure all |
| | information that is necessary to |
| | conduct a study has been entered. |
| | The user may save a draft to be |
| | viewed, or modified later, but a |
| | Protocol Representation cannot be |
| | deployed until all verification |
| | criteria have been satisfied. |
| Saving/ | The definition of the user's |
| Modifying | Protocol Representation will be |
| Protocol | saved on the corporate servers for |
| Representation | access by authorized users. The user |
| | can view the Protocol Representation |
| | at any time as well as modify it. |
| | Once a Protocol Representation has |
| | been deployed all proliferation of |
| | modifications will be handled by |
| | Services (modifications are version |
| | controlled so the user may refer to |
| | previous versions or can update |
| | existing ones). |

### EXAMPLE: CREATION OF A SPECIFIC PROTOCOL

FIG. 34 shows a process flow for defining a protocol using an XML-based representation, according to an embodiment of the present invention. First, a protocol is received 276, and a protocol representation is produced 278. Interfaces are demonstrated 280 to determine whether requirements are met 282. If the requirements are not met, then the interfaces are modified and demonstrated again 280.

Once the interfaces meet requirements, the site server is configured 284, and agent XML is produced 286. Notifications and auto-events are then tested 288. If requirements are not met, then the agent XML is modified 286 and notifications and auto-events are retested 288.

If notifications and auto-events function properly, then the home server is configured 292. After the home server is configured 292, all services are validated 294. Once validation of all services 294 has been completed, protocol specifications are stored 296, and the protocol is made available for deployment 298.

### EXAMPLE: CONFIGURATION OF A SPECIFIC SYSTEM

This example covers four basic types of systems. Three of these systems are available to customers and the fourth is used by in the performance of Services and plays a part in the total system configuration:

A corporate server system is located at a selected secure location that contains global Authorized user, Site, and Protocol Representation “standard” information for maintaining and creating Protocol Representations. A home server system is located at the Data center. A Site Server system is located at each Site using the disclosed system. Finally, a number of typically mobile Satellite systems are established for the collection of data in the field.

The Corporate Server is a system that will reside at the Data Center. This is the location where the “master” Protocol Representations and their versions are kept as well as common information for Protocol Representations that the BPI and other tools can use for common global referencing. This information includes default data definitions and constraint values as well as display defaults, medical term dictionaries, concomitant medication references and similar types of information. This server is generally not available to the customer but will be made available to staff that are tasked and authorized to use and modify the services on this server.

The Home Server is a system that will reside at the Data Center. This is the collection place for all the data from the various Sites for a particular study (Protocol). The Home Server also contains the “Master” Protocol Representation specifications that define all the parameters and data for a study. In this example, the Home Server is also the system which Authorized user's and “outside” study participants will access to view the information they seek.

The Site Server is a system that will reside at each location where studies are being conducted. Multiple studies can be conducted simultaneously at the Site using the same Site Server, and information will be sent to the Home Server at specified intervals. The Site Server is responsible for getting data from the Satellite machines as well as keeping them up-to-date with the current Protocol Representations.

Satellites are systems that data entry actually occurs on. They provide data for the Site Servers which invariably end up on the Home Server. These systems can be basically any type of system and can be used in two different modes. The type of hardware with which a Satellite system is implemented is dependent on the customer's demands but the target platform in this example may be a “Tablet PC.” These provide a number of options for data entry and should ease the transition to a “paper-less” study. The Satellite can run as an Internet client to the Site Server and connect via wireless configurations OR it can run as a standalone system and transfer its information to the Site Server when “docked”. This provides the utmost in flexibility and customer options.

### EXAMPLE: MAINTAINING SYNCHRONIZATION OF DATA

It is very common during the course of a study that changes occur. These changes can be the information that is being retrieved from the subjects, the report definitions, specific events, trend analysis, the notification list, etc. Since the disclosed system uses the Protocol Representation to define all of these, the systems themselves will look for new versions of the Protocol Representation at “appropriate” times. The following table outlines the process used in this example for using a new Protocol Representation.

| | |
|---|---|
| Protocol | Changes are requested by the |
| Representation | Authorized user, Services update |
| Validated | the Protocol Representation, and |
| | the updated Protocol |
| | Representation is approved by the |
| | customer. Then the next version of |
| | the Protocol Representation is |
| | saved to the Corporate Server. |
| Protocol | The Protocol Representation is |
| Representation | placed on the Home Server serving |
| made available | the Protocol. Messages are sent to |
| | all study participants that |
| | Protocol has changed. |
| Home Server | The Home Server will restart or |
| Updates | reinitialize any process or entity |
| | (reports, event monitoring) that |
| | is serving the Protocol. During |
| | this very brief amount of time, |
| | access to the Home Server will be |
| | denied to applications and persons |
| | alike. |
| Site Server | The Site Servers have a running |
| Updates | job with the Agent that will |
| | recognize that the Protocol |
| | Representation has changed and |
| | will pull it down. All services |
| | that require restarting or other |
| | initialization that needs to |
| | happen will be performed. |
| Satellites | Each Satellite has a running job |
| | that the Agent performs when the |
| | Satellite is docked to the docking |
| | station and therefore has access |
| | to the Site Server. During this |
| | docking time the Agent on the |
| | Satellite uploads all its recent |
| | and “un-uploaded” data. Subsequent |
| | to the data upload is the |
| | examination of the Protocol |
| | Representation on the Site Server |
| | which it will pull down and |
| | perform basically the same |
| | operations as the Site Server to |
| | make the new Protocol |
| | Representation current. |

### EXAMPLE: DOCUMENT MANAGEMENT

A major functionality and capability of the disclosed system is Document Management. The goal of the disclosed system is to significantly reduce or eliminate the amount of paper that is used during a study, but it is anticipated that paper documents will still be used in various portions of a study and these documents must be “managed” in order to maintain legal compliance with the various standards that apply to conducting studies (including FDA). These documents are considered “Source Documents” and must be made available as originating sources of data. In order to comply with these standards and to provide the user with a truly integrated system, the disclosed system provides several corresponding capabilities.

Scanners will be supplied, preconfigured where applicable, to scan documents in an approved format directly into the disclosed system. The document will be discovered by the disclosed system Application and will be made available to be associated to data form(s) or potentially the other Document Management functionalities. The user will be allowed to view the quality of the scan and can “rescan” if necessary. Once the scan is done, the scanned documents are migrated to an “unassociated” location waiting further processing by the user of the system. Information as to the time of scan will be recorded.

Documents contain data that is relevant to the study, however the information on the document does not necessarily have to be in a common format or organized to match the information required by a study. The disclosed system contains the ability to “associate” a document to a particular Visit or Data Form (such as Inventory). The user can associate a data form to a document in one of two ways. The first is to view the list of “unassociated” documents and then select the “Associate” functionality that will query the user for all information to associate the document to a particular subject and data form. The second method is to select the target subject and enable the proper data form and select the “Attach” function that will allow the user to associate the document(s) with the subject and data form. All information as to time of association, document origination, and user performing the association is recorded.

Since the documents are part of the study, they must be stored on the Site and Home Servers to be available to produce reports and regulatory documents as required by the Protocol. The disclosed system handles the proliferation of the documents to all of the systems that would require access to these documents once they have been integrated into the system. Should the document be scanned or faxed from a remote location such as a hospital or mobile unit, the document can be sent via email or the disclosed system Message Center (should the person with the original document have access to it) and subsequently integrated into the study.

It is anticipated that many scanned documents will contain information that has not yet been entered into the disclosed system. Therefore the disclosed system provides the ability to scan a document or take an existing scanned image and examine the document for data that can be derived using various text scanning capabilities. This same technology can be used to identify documents via bar codes or document numbers as well as to identify the target subject with bar codes and/or user identification codes.

Providing an electronic means to enter data in many instances does not translate to written text, nor is it necessarily conducive for data acquisition or printed page layouts. The disclosed system provides a means to print data forms with or without data values, which will provide the same information in the same order as its electronic counterpart, yet will provide a paper copy that can be used as data forms and subsequently scanned or associated into the disclosed system. This is useful for situations in which having a disclosed system satellite or data entry system is not feasible, practical or available. This can also be used at Sites that require “paper” backup for a specific study.

FIG. 35 illustrates a general purpose computing system that may be part of a network of such computing systems for employing an embodiment of the present invention's method and system for automated management of pharmaceutical research and reporting. By associating a network of general-purpose computers 300, the present invention facilitates reduction of costs and time required to develop a drug. In such an electronic conveyancing environment as established by the present invention, at least two such computers may be operated at different locations within a given geographical or similarly bounded area.

With reference to FIG. 35, general-purpose computer 300 may be a personal computer, a laptop, palmtop, or other set top, server, mainframe, and other variety computer, and include processing unit 302, system memory 304, and system bus 306 coupling various system components including system memory 304 to the processing unit 302. Processing unit 302 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 302.

System bus 306 may be any of several types of bus structures including a memory bus or memory controller, a peripheral bus, and a local bus using any of a variety of conventional bus architectures such as PCI, VESA, AGP, Microchannel, ISA and EISA, to name a few. System memory 304 includes read only memory (ROM) 308 and random access memory (RAM) 310. A basic input/output system (BIOS), containing the basic routines helping to transfer information between elements within the computer 300, such as during start-up, is stored in ROM 308.

Computer 300 further includes a hard disk drive 312, a floppy drive 314, e.g., to read from or write to a removable disk 316, and CD-ROM drive 318, e.g., for reading a CD-ROM disk 320 or to read from or write to other optical media. The hard disk drive 312, floppy drive 314, and CD-ROM drive 318 are connected to the system bus 306 by a hard disk drive interface 322, a floppy drive interface 324, and an optical drive interface 326, respectively. The drives and their associated computer-readable media provide nonvolatile storage of data, data structures, computer-executable instructions, etc., for computer 300. Although the description of computer-readable media provided above refers to a hard disk, a removable floppy and a CD, those skilled in the are may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 310, including an operating system 328, one or more application programs 330, other program modules 332, and program data 334. A consumer may enter commands and information into the computer 300 through a keyboard 336 and pointing device, such as mouse 338. Other input devices (not shown) may include a microphone, joystick, game pad, satellite dish, scanner, or the like. These and other input devices are often connected to the processing unit 302 through a serial port interface 340 coupling to the system bus, but possibly connecting by other interfaces, such as a parallel port, game port or a universal serial bus (USB). A monitor 342 or other type of display device is also connected to the system bus 306 via an interface, such as a video adapter 344. In addition to the monitor, computers typically include other peripheral output devices (not shown), such as speakers and printers.

Computer 300 may operate in a networked environment using logical connections to one or more remote computers, such as a remote computer 346. Remote computer 346 may be a server, a router, a peer device or other common network node, and typically includes many or all of the elements described relative to the computer 300, although only a memory storage device 348 has been illustrated in FIG. 35. The logical connections depicted in FIG. 35 include a local area network (LAN) 350 and a wide area network (WAN) 352. Such networking environments are commonplace in offices, enterprise-wide computer networks, intranets and the Internet.

When used in a LAN networking environment, the computer 300 is connected to the LAN 350 through a network interface or adapter 354. When used in a WAN networking environment, computer 300 typically includes a modem 356 or other means for establishing communications (e.g., via the LAN 350 and a gateway or proxy server) over the wide area network 352, such as the Internet. Modem 356, which may be internal or external, is connected to the system bus 306 via the serial port interface 340. In a networked environment, program modules depicted relative to the computer 300, or portions thereof, may be stored in the remote memory storage device 348.

Those skilled in the art may appreciate the network connections shown as being exemplary, wherein other means of establishing a communications link between the computers may be used. FIG. 35 only provides one example of a computer useful for employing the teachings of the present invention. The invention may be used in computers other than general-purpose computers, as well as on general-purpose computers without conventional operating systems.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for automated management of a clinical trial for pharmaceutical development that facilitates pharmaceutical research and reporting, comprising:
at least one site server each being associated with and communicably coupled to at least one computing device configured to collect primary clinical trial data using electronic data capture by providing interfaces through which users can enter data;
a central server communicably coupled via a network to each site server and communicably coupled via said network to an authorized user accessible computing device;
wherein each computing device configured to collect primary clinical trial data is adapted to validate data entered;
wherein each site server is configured to transmit the primary clinical trial data to the central server;
wherein the central server is configured:
to receive the primary clinical trial data from each site server;
to store the primary clinical trial data;
to create secondary clinical trial data based on the primary clinical trial data;
to transmit the primary and secondary clinical trial data to the authorized user accessible computing device.

2. The system of claim 1, wherein the primary clinical trial data comprises patient information.

3. The system of claim 1, wherein the secondary clinical trial data comprises a full audit trail.

4. The system of claim 1, wherein the secondary clinical trial data comprises study metrics created based on the primary clinical trial data through algorithmic analysis of said primary clinical trial data.

5. The system of claim 1, wherein the central server is further configured:
to transmit “same day” reports to the authorized user accessible computing device.

6. The system of claim 1, wherein the central server is further configured:
to transmit data to the authorized user accessible computing device that allows an authorized user using the authorized user accessible computing device to manage inventory associated with the managed clinical trial.

7. The system of claim 1, wherein the central server is further configured:
to transmit data to the authorized user accessible computing device that allows an authorized user using the authorized user accessible computing device to conduct online monitoring and audits of the managed clinical trial.

8. The system of claim 1, wherein said network further comprises a full-time, public access network and further comprising a central server communicably coupled via a full-time, public access network to each site server and communicably coupled via said full-time, public access network to an authorized user accessible computing device

9. The system of claim 8, wherein said full-time, public access network further comprises a secure channel and further comprising a central server communicably coupled via a full-time, public access network using a secure channel to each site server and communicably coupled via said full-time, public access network through said a secure channel to an authorized user accessible computing device

10. A method for automatically managing a clinical trial for pharmaceutical development in order to facilitate pharmaceutical research and reporting, comprising the steps of:
capturing electronic data corresponding to primary clinical trial data by the use by a user of a computing device configured with interfaces adapted to collect primary clinical trial data;
validating the electronic data;
distributing across a full-time, public network the electronic data after said data has been validated from the corresponding computing device to a central server;
creating secondary clinical trial data based on the primary clinical trial data;
storing the primary and secondary clinical trial data; and
making said stored primary and secondary clinical trial data available by the central server to be accessed across the full-time, public network by an authorized user accessible computing device.

11. The method of claim 10, wherein the step of capturing electronic data corresponding to primary clinical trial data by the use by the user of the computing device configured with interfaces adapted to collect primary clinical trial data comprises the step of:
capturing electronic data corresponding to patient information by the use by a user of a computing device configured with interfaces adapted to collect patient information.

12. The method of claim 10, wherein the step of creating secondary clinical trial data based on the primary clinical trial data comprises the step of:
creating a full audit trail based on the primary clinical trial data.

13. The method of claim 10, wherein the step of creating secondary clinical trial data based on the primary clinical trial data comprises the step of:
creating study metrics based on the primary clinical trial data through algorithmic analysis of said clinical trial data.

14. The method of claim 10, wherein the step of making said stored primary and secondary clinical trial data available by the central server to be accessed across the full-time, public network by the authorized user accessible computing device comprises the step of:
making “same day” reports available by the central server to be accessed across a full-time, public network by the authorized user accessible computing device.

15. The method of claim 10, wherein the step of making said stored primary and secondary clinical trial data available by the central server to be accessed across the full-time, public network by the authorized user accessible computing device comprises the step of:
making said stored primary and secondary clinical trial data sufficiently available by the central server to be accessed across the full-time, public network by the authorized user accessible computing device, thereby allowing an authorized user using the authorized user accessible computing device to manage inventory associated with the managed clinical trial.

16. The method of claim 10, wherein the step of making said stored primary and secondary clinical trial data available by the central server to be accessed across the full-time, public network by the authorized user accessible computing device comprises the step of:
making said stored primary and secondary clinical trial data sufficiently available by the central server to be accessed across the full-time, public network by the authorized user accessible computing device, thereby allowing an authorized user using the authorized user accessible computing device to conduct online monitoring and audits of the managed clinical trial.

17. A computer-readable signal capable of being propagated between computers and which contains a set of instructions for a general purpose computer having a user interface comprising a mouse and a screen display, the set of instructions comprising:
an input routine operatively associated with said user interface for permitting a user to select an icon displayed on said screen display with said mouse, said icon associated with an applications program accessible to said computer;
wherein execution of the applications program performs a method for automatically managing a clinical trial for pharmaceutical development in order to facilitate pharmaceutical research and reporting, comprising the steps of:
capturing electronic data corresponding to primary clinical trial data by the use by a user of a computing device configured with interfaces adapted to collect primary clinical trial data;
validating the electronic data;
distributing across a full-time, public network the electronic data after said data has been validated from the corresponding computing device to a central server;
creating secondary clinical trial data based on the primary clinical trial data;
storing the primary and secondary clinical trial data; and
making said stored primary and secondary clinical trial data available by the central server to be accessed across the full-time, public network by an authorized user accessible computing device.
a run routine for executing said applications program selected by the user with said mouse; and
a display routine responsive to said run routine for displaying on said screen display text or images generated by said applications program.

18. The signal of claim 17, wherein the step of capturing electronic data corresponding to primary clinical trial data by the use by the user of the computing device configured with interfaces adapted to collect primary clinical trial data comprises the step of:
capturing electronic data corresponding to patient information by the use by a user of a computing device configured with interfaces adapted to collect patient information.

19. The signal of claim 17, wherein the step of creating secondary clinical trial data based on the primary clinical trial data comprises the step of:
creating study metrics based on the primary clinical trial data through algorithmic analysis of said clinical trial data.

20. The signal of claim 17, wherein the step of making said stored primary and secondary clinical trial data available by the central server to be accessed across the full-time, public network by the authorized user accessible computing device comprises the step of:
making said stored primary and secondary clinical trial data sufficiently available by the central server to be accessed across the full-time, public network by the authorized user accessible computing device, thereby allowing an authorized user using the authorized user accessible computing device to manage inventory associated with the managed clinical trial.
